(19) United States
(12) Patent Application Publication
(10) Pub. No.: US 2012/0140496 A1
(43) Pub. Date: Jun. 7, 2012

(54) WAVELENGTH CONVERSION MEMBER, LIGHT EMITTING DEVICE, ILLUMINATING DEVICE, VEHICLE HEADLAMP, AND PRODUCTION METHOD

(75) Inventors: Katsuhiko KISHIMOTO, Osaka-shi (JP); Rina SATO, Osaka-shi (JP)

(73) Assignee: Sharp Kabushiki Kaisha, Osaka-shi (JP)

(21) Appl. No.: 13/312,551

(22) Filed: Dec. 6, 2011

(30) Foreign Application Priority Data
Dec. 7, 2010 (JP) 2010-272777
Dec. 7, 2010 (JP) 2010-272778
Jun. 27, 2011 (JP) 2011-142161

(51) Int. Cl. B60Q 1/00; C09K 11/08; F21V 9/16; C09K 11/02; B82Y 20/00

(52) U.S. Cl. 362/459; 362/84; 252/301.4 S; 977/779

(57) ABSTRACT

A headlamp according to an embodiment of the present invention includes a laser diode which emits a laser beam and a light emitting section which emits light upon receiving the laser beam. The light emitting section has heat-resistant (heat-tolerant) fluorescent material dispersed inside heat-resistant transparent sealing material. Accordingly, the headlamp is capable of functioning as a small-sized light source having high luminance and high luminous flux and which can be used for a long period of time.

This Nonprovisional application claims priority under 35 U.S.C. §119(a) on Patent Application No. 2010-272777 filed in Japan on Dec. 7, 2010, Patent Application No. 2010-272778 filed in Japan on Dec. 7, 2010, and Patent Application No. 2011-142161 filed in Japan on Jun. 27, 2011, the entire contents of which are hereby incorporated by reference.

### TECHNICAL FIELD

The present invention relates to a light emitting device functioning as a high-luminance light source, a wavelength conversion member of the light emitting device, and an illuminating device and a vehicle headlamp each including the light emitting device.

### BACKGROUND ART

In recent years, studies have been intensively carried out for light emitting devices that use, as illumination light, fluorescence emitted from a light emitting section which includes fluorescent material. The light emitting section emits the fluorescence upon irradiation with excitation light, which excitation light is emitted from an excitation light source. A semiconductor light emitting element is used as the excitation light source, such as a light emitting diode (LED), a laser diode (LD), or the like. Examples of techniques related to such a light emitting section are disclosed in Patent Literatures 1 through 7.

Patent Literature 1 discloses a gallium nitride LED whose casing member is formed of ceramics. The gallium nitride LED has fluorescent material be dispersed in low melting glass and has a filling member be made of low melting glass. This light emitting device aims to achieve a long life by using inorganic material for each of the members as described above, to prevent deterioration of the members caused by light having short wavelengths.

Patent Literature 2 discloses a light emitting device which prevents deterioration of fluorescent material caused by moisture, by dispersing fluorescent glass serving as fluorescent material into low melting glass. Examples of the low melting glass encompass Nb₂O₅ glasses, B₂O₃ glasses, P₂O₅—F glasses, P₂O₅—ZnO glasses, SiO₂—B₂O₃—La₂O₃ glasses, and SiO₂—B₂O₃ glasses.

Patent Literature 3 discloses a light emitting diode lamp in which a fluorescent-material-dispersed member made of low melting glass in which fluorescent material is dispersed is disposed between transparent resin and a light emitting diode. The amount of ultraviolet ray emitted from the light emitting diode is reduced by the fluorescent-material-dispersed member. This thus prevents deterioration of the resin caused by the ultraviolet rays, which as a result allows for achieving a long life of the light emitting diode lamp. PbO—SiO₂—B₂O₃ glasses and PbO—P₂O₅—SnF₂ glasses are exemplified as the low melting glass in Patent Literature 3.

Patent Literature 4 discloses a light emitting device including a wavelength conversion member in which fluorescent material is dispersed inside quartz glass. It is disclosed in Patent Literature 4 that it is particularly preferable that the quartz glass include any one or more of alkali metal oxides, alkaline earth metal oxides, boric acid, phosphoric acid, and zinc oxide. It is also disclosed therein that a wavelength conversion member is obtainable by mixing together fluorescent material and glass powder and molding this mixture by hot-press.

Patent Literature 5 discloses, as glass suitable as basic material for sealing fluorescent material, Al₂O₃, SiO₂, ZrO₂, ZnO, ZnSe, AlN, and GaN. Moreover, as the fluorescent material, Cu-activated zinc cadmium sulfide, cerium-activated YAG-type fluorescent material or LAG-type fluorescent material are exemplified in Patent Literature 5. Other than this, Patent Literature 5 discloses possible use of YAG, LAG, BAM, BAM:Mn, CCA, SCA, SCESN, SESN, CESN, CASBN, and CaAlSiN₃:Eu. Moreover, low melting glass (SnO-P₂O₅ glasses, CuO-P₂O₅ glasses, Bi₂O₃ glasses) is used for bonding the fluorescent material with a cap for covering the laser diode element.

In the invention of Patent Literature 6, ultraviolet light emitted from the semiconductor light emitting element is converged by a converging lens, and this converged ultraviolet light is emitted on fluorescent material of a small dot size having a diameter of not more than 0.5 mm. By carrying out optical design based on light emitted from a small region by use of this configuration, it is possible to easily carry out optical design of the light source unit.

Moreover, in the invention of Patent Literature 7, a wavelength conversion member is formed by calcining a mixture containing inorganic fluorescent material powder and glass powder. Patent Literature 7 discloses that it is preferable that a mixed ratio of the glass powder to the inorganic fluorescent powder is in a range of 99.99:0.01 to 70:30 in mass ratio.

Luminous efficiency of a fluorescent material complex member varies depending on a type and amount of the fluorescent material particles dispersed inside the glass, and further on the thickness of the fluorescent material complex member. If the fluorescent material complex member contains too much of the fluorescent member, the fluorescent material complex member becomes difficult to sinter and porosity increases. This as a result causes problems such as that the fluorescent material becomes difficult to be efficiently irradiated with excitation light, or that mechanical strength of the fluorescent material complex member easily decreases. On the other hand, if the amount of the fluorescent member is insufficient, it becomes difficult to sufficiently emit light. Consequently, it is disclosed that it is preferable to have the mixed ratio of the oxide glass powder to the inorganic fluorescent material powder be within the foregoing range.

Moreover, in a case where a high-luminance light source is to be accomplished, it is preferable to have the wavelength conversion member that serves as the light emitting section be small in size. Therefore, if laser beam is used as the excitation light, it is possible to excite the light emitting section with a high optical density. This makes it easier to accomplish a high-luminance light source.

Moreover, Patent Literature 8 discloses coated fluorescent particles in which fluorescent particles are coated with a glass composition containing one or more of alkali metals, alkali earth metals, and Zn.

Patent Literature 9 discloses a method of producing a fluorescent substance molded object by mixing fluorescent material powder with glass powder, melting the glass powder by discharge plasma sintering, and thereafter cooling the melted glass powder.

Moreover, Patent Literature 10 also discloses a wavelength conversion member made of a sintered object of a mixed powder including inorganic fluorescent material powder and glass powder. A main characteristic of the invention of Patent Literature 10 is that a band pass filter layer is provided on the surface of the wavelength conversion member, which band pass filter layer selectively transmits light of a wavelength range including an excitation light wavelength.

### CITATION LIST

### Patent Literature

Patent Literature 1
Japanese Patent Application Publication, Tokukai, No. 2004-200531 A (Jul. 15, 2004)

Patent Literature 2
Japanese Patent Application Publication, Tokukai, No. 2004-273798 A (Sep. 30, 2004)

Patent Literature 3
Japanese Patent Application Publication, Tokukai, No. 2006-32500 A (Feb. 2, 2006)

Patent Literature 4
Japanese Patent Application Publication, Tokukai, No. 2007-324239 A (Dec. 13, 2007)

Patent Literature 5
Japanese Patent Application Publication, Tokukai, No. 2009-105125 A (May 14, 2009)

Patent Literature 6
Japanese Patent Application Publication, Tokukai, No. 2004-241142 A (Aug. 26, 2004)

Patent Literature 7
Japanese Patent Application Publication, Tokukai, No. 2008-21868 A (Jan. 31, 2008)

Patent Literature 8
Japanese Patent Application Publication, Tokukai, No. 2009-13186 A (Jan. 22, 2009)

Patent Literature 9
Japanese Patent Application Publication, Tokukai, No. 2009-91546 A (Apr. 30, 2009)

Patent Literature 10
Japanese Patent Application Publication, Tokukai, No. 2010-108965 A (May 13, 2010)

### SUMMARY OF INVENTION

### Technical Problem

By using a laser diode and not a typical light emitting diode as a light source for exciting the fluorescent material contained in the light emitting section, it is possible to efficiently converge excitation light to a narrow region. This hence allows for achieving a light source having a higher luminance. However, the inventions of the foregoing Patent Literatures do not consider the excitation of the light emitting section with high-powered laser beams; the inventor of the present invention found out that if the light emitting section were irradiated with such high-powered laser beams, the light emitting section would deteriorate.

Moreover, if the wavelength conversion member was made small, the total amount of the fluorescent material contained in the wavelength conversion member would be reduced in amount. On this account, the inventor of the present invention found out that if this small-sized wavelength conversion member were excited with an extremely strong light (high-powered light) such as laser beams having a high optical density, the amount of fluorescent material would be insufficient with respect to the amount of excitation light (the excitation light cannot be fully absorbed), and a sufficient amount of fluorescence cannot be attained as compared to the amount of excitation light.

To improve this state, the wavelength conversion member is to be made to contain the fluorescent material as much as possible. However, an increase in the amount of fluorescent material (i.e. an increase in density of the fluorescent material) causes the fluorescent material to be intensified in generation of heat caused by the excitation by the laser beams. Hence, it is becoming revealed that this would conversely cause other problems such as that not enough fluorescence can be obtained or alternatively that effect is given on properties (e.g. chromaticity/color temperature, life) of the wavelength conversion member which effect causes deterioration of the wavelength conversion member.

The inventor of the present invention found that, in order to solve these problems, a technique to evenly disperse the fluorescent material in a small wavelength dispersion member is extremely important. This is because even if the same amount of fluorescent material is used, with a locally unbalanced density, the generation of heat in the high density region becomes relatively large as compared to other regions of the wavelength dispersion member having a lower density. As a result, not enough fluorescence may be obtained from the high density region, or effect may be given on the properties (chromaticity/color temperature, life) of the wavelength conversion member, which cause deterioration of the wavelength conversion member. Namely, the more evenly the fluorescent material is dispersed, the more the total amount of the fluorescent material which can be dispersed inside the small wavelength conversion material is increased.

As such, it is an important point in accomplishing a high-luminance light source with use of the laser beams that the fluorescent material is evenly dispersed inside the sealing material and that the size of the wavelength conversion member is small.

However, no technique allowing for evenly dispersing fluorescence material particles inside a small wavelength conversion member has been accomplished until now.

The present invention is accomplished to solve the foregoing problems, and an object thereof is to provide a light emitting device including a small-sized and highly heat-resistant (heat-tolerant) light emitting section having high luminance and high luminous flux, and to provide an illuminating device including the light emitting device. Moreover, another object of the present invention is to provide a production method in which fluorescent material particles are evenly dispersed inside a wavelength conversion member, and to provide a wavelength conversion member in which particles of the fluorescent material are evenly dispersed.

### Solution to Problem

In order to attain the object, a light emitting device according to one embodiment of the present invention includes a laser diode configured to emit a laser beam; and a light emitting section configured to emit light upon receiving the laser beam emitted from the laser diode, the light emitting section having heat-resistant (heat-tolerant) fluorescent material being dispersed inside heat-resistant transparent sealing material.

According to the configuration, the light emitting section emits light upon irradiation of the light emitting section with a laser beam emitted from the laser diode.

The inventor of the present invention found that the light emitting section deteriorates severely if the light emitting section is excited with high-powered laser beams. The deterioration of the light emitting section is mainly caused by (i) the deterioration of the fluorescent material contained in the light emitting section and (ii) the deterioration of the sealing material surrounding the fluorescent material. For example, sialon fluorescent material, which is one example of oxynitride fluorescent material, emits light with an efficiency of 60% to 90% upon irradiation with the laser beams. However, the remainder just serves as a cause for generation and discharging of heat. It is thought that the sealing material deteriorates caused by this heat.

According to the configuration, the light emitting section is formed by dispersing heat-resistant fluorescent material in heat-resistant transparent sealing material. This thus makes it possible to prevent the deterioration of the light emitting section caused by heat, and as a result allows for achieving a small-sized light emitting device which is a light source having high luminance and high luminous flux, and which can be used for a long period of time.

In order to attain the object, a wavelength conversion member according to one embodiment of the present invention is a wavelength conversion member including: fluorescent material converting a wavelength of excitation light; and sealing material sealing the fluorescent material, the fluorescent material having a density of not less than 2.5 g/cm³ but not more than 4.0 g/cm³ and the sealing material having a density of not less than 2.0 g/cm³ but not more than 7.0 g/cm³ where the fluorescent material has an average particle size of not smaller than 1 μm but not larger than 50 μm, and the fluorescent material having a density of not less than 6.0 g/cm³ but not more than 7.0 g/cm³ and the sealing material having a density of not less than 2.0 g/cm³ but not more than 12 g/cm³ where the fluorescent material has an average particle size of not larger than 50 nm.

A production method according to one embodiment of the present invention is a method of producing a wavelength conversion member, the method including the steps of: (a) mixing fluorescent material with sealing material, the fluorescent material having a density of not less than 2.5 g/cm³ but not more than 4.0 g/cm³ and the sealing material having a density of not less than 2.0 g/cm³ but not more than 7.0 g/cm³ where the fluorescent material has an average particle size of not smaller than 1 μm but not larger than 50 μm, and the fluorescent material having a density of not less than 6.0 g/cm³ but not more than 7.0 g/cm³ and the sealing material having a density of not less than 2.0 g/cm³ but not more than 12 g/cm³ where the fluorescent material has an average particle size of not larger than 50 nm; and (b) treating a mixture of the fluorescent material and the sealing material prepared in the step (a), by heat.

According to the configuration, when the wavelength conversion member is irradiated with excitation light, the fluorescent material contained in the wavelength conversion member converts the excitation light into fluorescence. By sealing this fluorescent material with sealing material, the wavelength conversion member is formed.

When the fluorescent material is dispersed into the sealing material, it is preferable that the fluorescent material is dispersed evenly in the sealing material. This is because if the distribution of the fluorescent material is unbalanced, the wavelength conversion member may deteriorate caused by generation of excess heat at which the fluorescent material is congregated.

The inventor of the present invention, as a result of diligent study, found that in order to evenly disperse the fluorescent material in the sealing material, it is important to have both materials have an appropriate density.

More specifically, in a case where the fluorescent material has an average particle size of 1 μm but not more than 50 μm, the fluorescent material can be evenly dispersed into the sealing material by having the fluorescent material have a density of not less than 2.5 g/cm³ but not more than 4.0 g/cm³ and the sealing material have a density not less than 2.0 g/cm³ but not more than 7.0 g/cm³.

Moreover, in a case where the fluorescent material has an average particle size of not more than 50 nm (however is more than 0), it is possible to evenly disperse the fluorescent material into the sealing material by having the density of the fluorescent material be not less than 6.0 g/cm³ but not more than 7.0 g/cm³ and the sealing material be not less than 2.0 g/cm³ but not more than 12 g/cm³.

By setting the density of the sealing material and the fluorescent material as such, it is possible to evenly disperse the fluorescent material into the sealing material, and as a result, hold down the deterioration of the wavelength conversion member and extend its life.

### Advantageous Effects of Invention

As described above, a light emitting device according to one embodiment of the present invention includes: a laser diode configured to emit a laser beam; and a light emitting section configured to emit light upon receiving the laser beam emitted from the laser diode, the light emitting section having heat-resistant (heat-tolerant) fluorescent material being dispersed inside heat-resistant transparent sealing material.

This brings about an effect of accomplishing a small-sized light emitting device having high luminance and high luminous flux that allows for preventing the deterioration of the light emitting section and which functions as a light source that can be used for a long period of time.

Moreover, as described above, a wavelength conversion member according to one embodiment of the present invention is a wavelength conversion member including: fluorescent material converting a wavelength of excitation light; and sealing material sealing the fluorescent material, the fluorescent material having a density of not less than 2.5 g/cm³ but not more than 4.0 g/cm³ and the sealing material having a density of not less than 2.0 g/cm³ but not more than 7.0 g/cm³ where the fluorescent material has an average particle size of not smaller than 1 μm but not larger than 50 μm, and the fluorescent material having a density of not less than 6.0 g/cm³ but not more than 7.0 g/cm³ and the sealing material having a density of not less than 2.0 g/cm³ but not more than 12 g/cm³ where the fluorescent material has an average particle size of not larger than 50 nm.

Moreover, a production method according to one embodiment of the present invention is a method of producing a wavelength conversion member, the method including the steps of: (a) mixing fluorescent material with sealing material, the fluorescent material having a density of not less than 2.5 g/cm³ but not more than 4.0 g/cm³ and the sealing material having a density of not less than 2.0 g/cm³ but not more than 7.0 g/cm³ where the fluorescent material has an average particle size of not smaller than 1 μm but not larger than 50 μm, and the fluorescent material having a density of not less than 6.0 g/cm³ but not more than 7.0 g/cm³ and the sealing material having a density of not less than 2.0 g/cm³ but not more than 12 g/cm³ where the fluorescent material has an average particle size of not larger than 50 nm; and (b) treating a mixture of the fluorescent material and the sealing material prepared in the step (a), by heat.

Hence, it is possible to evenly disperse the fluorescent material into the glass material, and as a result, prevent the deterioration of the wavelength conversion member and extend the life of the wavelength conversion member.

### BRIEF DESCRIPTION OF DRAWINGS

FIG. 1 is a view schematically illustrating a configuration of a headlamp of an embodiment in accordance with the present invention.

FIG. 2(a) schematically illustrates a circuit diagram of a laser diode included in the headlamp.

FIG. 2(b) is a perspective view illustrating a basic configuration of the laser diode.

FIG. 3 is a view schematically illustrating a configuration of a headlamp according to another embodiment of the present invention.

FIG. 4 is a graph illustrating a relationship of internal and external quantum efficiency of SCASN fluorescent material with heat-treatment temperatures.

FIG. 5 is a graph illustrating absorptance of light of different waveforms, of fluorescent material which has been subjected to heat treatment.

FIG. 6 is a view schematically illustrating a configuration of a headlamp according to the present embodiment.

FIG. 7 is a view illustrating an emission spectrum in a case where Caα-SiAlON:Ce and Caα-SiAlON:Eu are used as fluorescent material.

FIG. 8 is a view schematically illustrating a configuration of a headlamp according to yet another embodiment of the present invention.

FIG. 9 is a view illustrating an emission spectrum in a case where β-SiAlON:Eu and CASN:Eu is used as fluorescent material.

FIG. 10 is a cross sectional view illustrating a ceiling on which a laser downlight according to one embodiment of the present invention is disposed.

FIG. 11 is a cross sectional view of the laser downlight.

FIG. 12 is a cross sectional view illustrating a modification of a method of disposing the laser downlight.

FIG. 13 is a graph showing a relationship of an average particle size of semiconductor nanoparticle fluorescent material with fluorescence wavelengths.

FIG. 14(a) is a view describing a preferable added amount of a dispersion medium.

FIG. 14(b) is a view describing a preferable added amount of the dispersion medium.

FIG. 14(c) is a view describing a preferable added amount of the dispersion medium.

FIG. 15 is a view illustrating a specific example of a coefficient fi for calculating a thermal conductivity κ of glass at three temperatures, which thermal conductivity κ is calculated from a weight percentage of an oxide component.

### DESCRIPTION OF EMBODIMENTS

### Embodiment 1

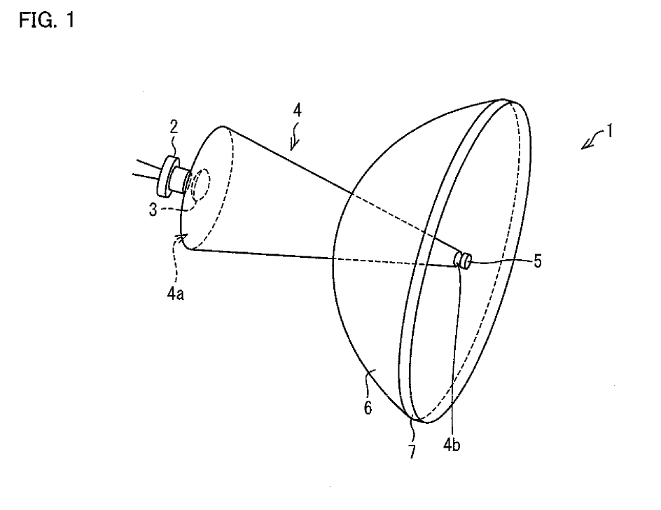

The following describes an embodiment of the present invention, with reference to FIG. 1 through FIG. 3. In the embodiment, a car headlamp (vehicle headlamp) 1 complying with light distribution characteristic standards of a running headlamp (driving beam) is described as an example of an illuminating device of the present invention. However, the illuminating device of the present invention may be a dipped beam headlamp (passing beam), and may be accomplished as a headlamp for a vehicle or a moving object other than a car (e.g., human, ship, aircraft, submarine, rocket), or as other illuminating devices. The other illuminating devices encompass, for example, a searchlight, a projector, home illuminating devices, commercial illuminating devices, outdoor illuminating devices and like devices.

<Configuration of Headlamp 1>

First described is a configuration a headlamp 1 according to the present embodiment, with reference to FIG. 1. FIG. 1 is a view schematically illustrating the configuration of the headlamp 1 according to the present embodiment. As illustrated in FIG. 1, the headlamp 1 includes a laser diode 2, an aspherical lens 3, a light guiding section 4, a light emitting section 5, a reflecting mirror 6, and a transparent plate 7. A basic configuration of the light emitting device is made up by the laser diode 2, the light guiding section 4, and the light emitting section 5.

(Laser Diode 2)

The laser diode 2 functions as an excitation light source that emits excitation light. This laser diode 2 may be one, or a plurality thereof may be disposed. Moreover, as the laser diode 2, a chip on which one light emitting point is provided may be used, or a chip on which a plurality of light emitting points are provided may be used. The present embodiment uses one of the laser diode 2 that has one light emitting point per chip.

The laser diode 2, for example, has one light emitting point (one stripe) per chip, emits a laser beam of 405 nm (blue violet), has an optical output of 1.0 W, an operating voltage of 5 V and an operating current of 0.6 A, and is sealed in a package (stem) having a diameter of 5.6 mm. The laser beam emitted from the laser diode 2 is not limited to 405 nm, and may be any laser beam as long as the laser beam has a peak wavelength in a wavelength range of not less than 380 nm but not more than 470 nm.

If it is possible to produce a good-quality laser diode for a short wavelength that emits a laser beam having a wavelength smaller than 380 nm, or alternatively, if it is possible to use fluorescent material which is excited efficiently with a laser beam having a wavelength of not less than 470 nm, it is also possible to use a laser diode which is designed to emit a laser beam having a wavelength in a wavelength range of not less than 350 nm but not more than 1000 nm. This is because, the fluorescent material that is usable as the light emitting section is generally excited efficiently in a range of not less than 350 nm but not more than 470 nm.

It is currently difficult to produce a light emitting section which is caused to emit fluorescence in a visible light range by the light emitting section being irradiated with laser beams L whose wavelength exceeds 1000 nm.

It is preferable that an optical output of the laser diode 2 be not less than 1 W but not more than 20 W and an optical density (emission density) of the laser beam emitted to the light emitting section 5 be not less than 0.1 W/mm² but not more than 50 W/mm². With an optical output in this range, it is possible to achieve a luminous flux and a luminance required of a vehicle headlamp, and this range allows for preventing the light emitting section 5 from extremely deteriorating caused by a laser beam too high in output. Namely, it is possible to achieve a long-lived light source which also is high in luminous flux and high in luminance.

(Aspherical Lens 3)

An aspherical lens 3 is a lens for causing the laser beam emitted from the laser diode 2 to enter an entering end 4a, which entering end 4a is one end of the light guiding section 4. For example, FLKN1 405 manufactured by ALPS ELECTRIC CO., LTD. may be used as the aspherical lens 3. As long as the lens has the foregoing function, the aspherical lens 3 is not particularly limited in its shape and material. However, it is preferable that the material has high transmittance with a wavelength in the vicinity of 405 nm, i.e. the wavelength of the excitation light, and that the material has good heat resistance (heat tolerance).

(Light Guiding Section 4)

The light guiding section 4 is a light guiding member of a circular truncated cone shape, for converging the laser beam emitted from the laser diode 2 and guiding the laser beam to the light emitting section 5 (a laser beam-irradiated surface of the light emitting section 5). The light guiding section 4 is optically combined with the laser diode 2 via the aspherical lens 3. The light guiding section 4 has a light receiving surface (entrance end part) 4a and a light emitting surface (exit end part) 4b. The light guiding section 4 receives the laser beam from the laser diode 2 through the light receiving surface 4a, and emits the laser beam received through the light receiving surface 4a to the light emitting section 5 through the light emitting surface 4b.

The light emitting surface 4b has an area smaller than that of the light receiving surface 4a. Hence, the laser beam incident on the light receiving surface 4a is converged by proceeding forwards while being reflected on sides of the light guiding section 4, and thereafter is emitted from the light emitting surface 4b.

The light guiding section 4 is made of silica glass, acrylic resin or other transparent material. Moreover, the light receiving surface 4a and the light emitting surface 4b may be either flat or curved.

A coupling efficiency of the aspheric lens 3 and the light guiding section 21 (i.e., a ratio of an intensity of a laser beam from the light emitting surface 4b of the light guiding section 4 with respect to an intensity of the laser beam from the laser diode 2) is 90%. That is, if an intensity of the laser beam from the laser diode 2 as a whole is 12 W, then an intensity of the laser beam will be 10.8 W when emitted from the light emitting surface 4b, upon passing through the aspheric lens 3 and the light guiding section 4.

The light guiding section 4 may be of a truncated pyramid shape or may be an optical fiber, as long as the laser beams emitted from the laser diode 2 is guided to the light emitting section 5. Moreover, the light emitting section 5 may be, directly or via the aspherical lens 3, irradiated with the laser beam emitted from the laser diode 2 without providing the light guiding section 4. If the distance between the laser diode 2 and the light emitting section 5 is short, such a configuration can possibly be taken.

(Light Emitting Section 5)

The light emitting section 5 emits light upon receiving the laser beam emitted from the light emitting surface 4b of the light guiding section 4, and includes heat-resistant fluorescent material (hereinafter, referred to simply as fluorescent material) emitting light upon receiving the laser beam, dispersed inside a heat-resistant transparent sealing material (hereinafter, referred to simply as sealing material).

The fluorescent material is, for example, oxynitride fluorescent material, nitride fluorescent material, or semiconductor nanoparticle fluorescent material using nanometer-sized particles of a III-V compound semiconductor, and fluorescent material of blue, green and red are dispersed in the low melting glass. The laser diode 2 emits a laser beam of 405 nm (blue violet), thereby causing generation of white light upon irradiation of the light emitting section 5 with the laser beam. On this account, it can be said that the light emitting section 5 is a wavelength conversion member. Details of the composition of the light emitting section 5 are described later.

The laser diode 2 may emit a laser beam of 450 nm (blue) (or a laser beam close to what is called “blue” having a peak wavelength in a wavelength range from not less than 440 nm to not more than 490 nm), and in this case, the fluorescent material is yellow fluorescent material, or a mixture of green fluorescent material and red fluorescent material. The yellow fluorescent material is fluorescent material which emits light having a peak wavelength in a wavelength range of not less than 560 nm to not more than 590 nm. The green fluorescent material is fluorescent material which emits light having a peak wavelength in a wavelength range of not less than 510 nm to not more than 560 nm. The red fluorescent material is fluorescent material which emits light having a peak wavelength in a wavelength range of not less than 600 nm to not more than 680 nm.

The light emitting section 5 is fixed on a focus position of the reflecting mirror 6 or in the vicinity of the focus position, on an inner surface (surface on a side on which the light emitting surface 4b is positioned) of the transparent plate 7. How the position of the light emitting section 5 is fixed is not limited to this method. For instance, the position of the light emitting section 5 may be fixed by use of a stick-shaped or cylinder-shaped member which extends out from the reflecting mirror 6.

The shape of the light emitting section 5 is not particularly limited, and may be a rectangular parallelepiped or a cylindrical shape. In the present embodiment, the light emitting section 5 is of a cylindrical shape having a diameter of 3.5 mm and a thickness of 2 mm. In this case, the area of the laser beam irradiated surface which receives the laser beam from the laser diode 2 and the area of a surface facing the laser beam irradiated surface are approximately 9.6 mm². Moreover, the light emitting section 5 may be, for example, of a cylindrical shape having a diameter of 2 mm and a thickness of 1 mm.

Moreover, the thickness between the laser beam irradiated surface and the light emitting surface in the light emitting section 5 is not limited to 1 mm or 2 mm. The thickness may be any thickness as long as the laser beam is entirely converted into white light at the light emitting section 5 or the laser beam is sufficiently scattered in the light emitting section 5.

The thickness required of the light emitting section 5 varies in accordance with a ratio of the sealing material to the fluorescent material in the light emitting section 5. As the content of fluorescent material increases in the light emitting section 5, the thickness of the light emitting section 5 can be reduced since the efficiency of converting the laser beam to white light increases.

However, as to the thickness of the light emitting section 5, it is preferable that the thickness is set not just in view of the point described above, but also in view of the matters described below. The light emitting section 5 has a function of diffusing laser beams. This function is accomplished by use of a difference in refractive index between the fluorescent material and the sealing material contained in the light emitting section. Hence, the light emitting section 5 is designed to have a volume (particularly thickness) which allows for sufficiently diffusing the laser beam emitted from the laser diode 2.

That is to say, the light emitting section 5 is to have a thickness which allows for excitation light to be converted into fluorescence by the fluorescent material, i.e., which allows for coherent light to be converted into incoherent light, or allows for having the coherent light be scattered to become coherent light that is harmless to the human body while the coherent light transmits through the light emitting section 5.

Moreover, diffusing particles may be contained in the light emitting section 5 in order to further enhance the diffusing function of the light emitting section 5 or to reduce the size of the light emitting section 5. As the diffusing particles, particles of zirconium oxide, diamond or the like may be used. Particles other than these may also be used, however it is preferable that the particle can tolerate the heat generated by the light emitting section 5.

Since the light emitting section 5 has a diffusing function, it is possible to convert a highly coherent laser beam emitted from the laser diode 2 from an extremely small light emitting point to a large beam having a size of the light emitting point which large beam gives fewer effect on the human body, and have the light emitting section 5 emit this large beam as illumination light.

(Reflecting Mirror 6)

The reflecting mirror 6 reflects incoherent light (hereinafter, referred simply as “light”) emitted from the light emitting section 5 to form a pencil of rays which travels within a predetermined solid angle. Namely, the reflecting mirror 6 causes formation of a pencil of rays which travels forwards of the headlamp 1, by having the light emitted from the light emitting section 5 be reflected by the reflecting mirror 6. The reflecting mirror 6 is, for example, a curved plane shaped (cup-shaped) member on which surface a metal thin film is formed, and is opened in a progressing direction of the reflected light.

(Transparent Plate 7)

The transparent plate 7 is a transparent resin plate covering the opening of the reflecting mirror 6, and supports the light emitting section 5. It is preferable to form the transparent plate 7 with material which transmits most of illumination light emitted from the light emitting section 5. As the transparent plate 7, an inorganic glass plate or the like may also be used other than the resin plate.

The illumination light in the embodiment denotes light discharged from the light emitting section 5 after the light emitting section 5 is irradiated with the laser beams.

More specifically, in a case where the laser beams with which the light emitting section 5 is irradiated is converted into fluorescence by the fluorescent material dispersed in the light emitting section 5, the fluorescence itself emitted from the light emitting section 5 is called the illumination light. In this case, the fluorescence is emitted from the light emitting section 5 to an external space where the light emitting section 5 is disposed, by the fluorescence being guided through glass material that serves as the sealing material, or being guided through the glass material after the fluorescence is scattered several times by the fluorescent material. At this time, the fluorescence can be considered macroscopically as discharged from the entire light emitting section 5.

Moreover, in a case where a part of the laser beam with which the light emitting section 5 is irradiated is not converted into the fluorescence by the fluorescent material dispersed in the light emitting section 5, the laser light not converted into the fluorescence and the laser light converted into the fluorescence, in other words, light in which the fluorescence is mixed, is called the illumination light. In this case, a portion of the laser beam is scattered several times by the fluorescent material inside the light emitting section 5 while the wavelength of the laser beam itself is maintained, is guided through while this laser beam is being diffused, and is thereafter discharged outside the light emitting section 5. On the other hand, the remaining laser beam either is converted in wavelength by the fluorescent material to be made into fluorescence and is guided through glass material that serves as the sealing material, or is scattered by the fluorescent material and guided through the glass material. In this case, both light of (i) the laser beam which was not wavelength converted and (ii) the fluorescence are discharged from the light emitting section 5 to an external space where the light emitting section 5 is disposed.

In this case also, it is possible to consider macroscopically that illumination light is discharged from the entire light emitting section 5.

The illumination light is designed to have a desired chromaticity and luminous flux, and irradiation intensity of the laser beam and the density of the fluorescent material inside the light emitting section are controlled by parameters.

As in the configuration of the present embodiment, by irradiating the light emitting section 5 having a diameter of 2 mm with a laser beam, it is possible to enlarge the laser beam emitted from the laser diode 2, that is, enlarge a spatial coherency of a laser beam which is coherent light emitted from an extremely small light emitting point of micrometer level, to the diameter of 2 mm which is the size of the light emitting section. This allows for converting the coherent light into incoherent light. Hence, it is possible to make this a light source which secures safety of the eyes of the human body.

Moreover, in a case where LED is used as the excitation light source that emits excitation light, there is the possibility that effect is given on the skin or eyes of the human body if excitation light in an ultraviolet region (not less than 350 nm but not more than 380 nm, or not more than 400 nm) is emitted. Hence, it is preferable to select, as the transparent plate 7, a plate that can block light being not more than 400 nm.

In order to accomplish a light source which uses a light source having a small light emitting point such as the laser beam while securing the safety, there is a need to enlarge the size of the light emitting point and convert most of the laser beams into the fluorescence at the light emitting section 5, or to have the laser beams be scattered or diffused several times.

In the embodiment, the transparent plate 7 transmits illumination light made of fluorescence or illumination light made of fluorescence and laser beams, however the light transmitted through the transparent plate 7 is not limited to these light. As long as the light transmitted through the transparent plate 7 has a desired chromaticity and luminous flux, the transparent plate 7 may intentionally block a specific wavelength region of the illumination light made of fluorescence or the illumination light made of fluorescence and laser beams. For instance, in a case where the illumination light made of fluorescence and laser beams are discharged from the light emitting section 5, the transparent plate 7 may be made of material which blocks the wavelength region of the laser beam and transmits most of the wavelength region of the fluorescence.

<Safety>

In a case where light of high energy is incident on an eye of a human, which light is emitted from a light source having a small light emitting point size, the light source image is reduced to the size of the small light emitting point on the retina, so therefore the energy density on the image-formed part may become extremely high. For example, a laser beam emitted from a laser source (laser diode) may have a spot size smaller than a 10 μm square. If the laser beam emitted from such a light source is incident on the eye directly or via an optical member such as a lens or a reflecting mirror in such a manner that the small light emitting point is directly seen by the eye, this may cause damage to the image-formed part on the retina.

A typical size of the light emitting point in a high-output laser diode is, for instance, 1 μm×10 μm. Namely, an emission area of the laser diode is 10 μm²=1.0×10⁻⁵ mm². Hence, even if the light emitted by the laser diode is for example light having a same energy as a light source having a light emitting point size of 1 mm², the energy density on the image-formed part on the retina in the case of the laser diode is higher by 10⁵ times more than the light source which has the light emitting point size of 1 mm².

In order to avoid this, it is necessary to enlarge the size of the light emitting point to a certain size (finite size) (more specifically, for example not smaller than 1 mm×1 mm). Enlarging the size of the light emitting point allows for enlarging the size of the image formed on the retina. Hence, even if light having the same energy is incident on the eye, the energy density on the retina can be reduced.

In order to enlarge the size of the light emitting point, the light emitting point of the light source requires to be not visualized. On this account, the present embodiment provides the light emitting section 5 with a diffusing function as described above, to enlarge the size of the light emitting point of the laser diode 2. This secures the safety of the human body, particularly of the eye of a human (eye-safe).

<Configuration of Light Emitting Section 5>

The inventor of the present invention found that the light emitting section deteriorates severely if the light emitting section is excited with a high-powered laser beam. The deterioration of the light emitting section is mainly caused by deterioration of the fluorescent material contained in the light emitting section together with deterioration of the sealing material which surrounds the fluorescent material. For example, sialon fluorescent material emits light with an efficiency of 60% to 90% upon irradiation with the laser beam, however the remainder just serves as a cause for generation and emission of heat. It is thought that the sealing material deteriorates due to this heat.

Accordingly, in extending the life of the light emitting section, it is extremely important to appropriately select the property of the sealing material and fluorescent material. In view of this, the light emitting section 5 uses as the sealing material a material in which the fluorescent material is dispersed inside glass material. By having the sealing material be glass material, it is possible to prevent the sealing material from remarkably deteriorating due to the heat generated when exciting the fluorescent material.

(Property of Sealing Material and Mixed Ratio)

Glass material such as inorganic glass and so-called inorganic-organic hybrid glass may be used as the sealing material, and particularly low melting glass is preferably used. As the low melting glass, ones having a glass transition point of not more than 600° C. is preferable, and the low melting glass preferably contains at least one of SiO₂, B₂O₃, and ZnO. By adding SiO₂, B₂O₃, or ZnO, it is possible to reduce the glass transition point and heat treatment temperature while stabilizing the low melting glass, and can further maintain its transparency.

An example of a composition of the glass material is SiO₂—B₂O₃—CaO—BaO—Li₂O—Na₂O.

Since glass has high heat resistance, use of glass material as the sealing material allows for preventing the deterioration of the light emitting section 5 even if the fluorescent material is irradiated with the laser beam and the fluorescent material generates heat. Moreover, the sealing material is not easily discolored as with the case where silicone resin is used as the sealing member, which discoloring is caused by the resin being irradiated with light for a long time.

In a case where the low melting glass is used as the sealing material, it is preferable that a volume ratio is not less than 1:1000 but not more than 1:1, where a mixed ratio of the fluorescent material to low melting glass is represented by the volume ratio. The fluorescent material here denotes a total amount of fluorescent material already mixed to achieve a white color. Moreover, the low melting glass has a density of approximately 3 g/cm³ to 7 g/cm³. Moreover, it is preferable that a range of a mass ratio of the fluorescent material to the low melting glass (fluorescence:low melting glass) is not less than 0.5:100 and not more than 20:100, where the mixture ratio is represented by the mass ratio.

A glass material which adds CaO—BaO—Li₂O—Na₂O to borosilicate glass (SiO₂—B₂O₃) to lower the melting temperature is used as the low melting glass. This glass material has low reactivity with fluorescent material. It is considered that other low melting glass that has low reactivity with the fluorescent material attains a similar result. On the other hand, if the low melting glass is glass material that reacts with the fluorescent material, the fluorescent glass material may decrease in luminous efficiency just by the sintering the glass material in order to produce the light emitting section.

Moreover, in a case where organic-inorganic hybrid glass is used as the sealing material, a preferable range of mass ratio of fluorescent material to organic-inorganic hybrid glass (fluorescence:hybrid glass) is not less than 5.13:200 but not more than 50:200.

The inventor of the present invention obtained this foregoing numerical range as a result of experimentation. In the experiment, luminous efficiency was calculated for a plurality of samples (sintered) each having a different mixed ratio, in order to identify a range of the mixed ratio which can achieve a luminous efficiency good enough to for practical use as the sealing material. Since the specific gravity is different between the hybrid glass and glass material, preferable mixed ratios are obtained separately.

In a case where the low melting glass is used as the sealing material, the fluorescent material can be evenly dispersed in the prepared light emitting section 5 with a mass ratio of the fluorescent material to the low melting glass of not less than 0.5:100. If the fluorescent material density is lower than 0.5:100, most of excitation light is transmitted through the light emitting section 5 as it is, and as a result not enough illumination light can be obtained. Hence, it is preferable that the mass ratio be not less than 0.5:100.

The mass ratio is further preferably not less than 1.0:100, in a case where the illuminating device of the present invention is to be accomplished as a transmission laser illuminating equipment. With the mass ratio of not less than 1.0:100, it is possible to scatter the laser beam used as the excitation light by use of the fluorescent material particles. This decreases the coherence of the laser beam.

On the other hand, if the fluorescent material density were made higher than 20:100, a surface of the light emitting section 5 would roughen and become extremely brittle. Hence, a portion of the light emitting section 5 may easily crack due to physical contact or the like. On this account, it is preferable that the mass ratio be not more than 20:100.

The light emitting section 5 can be used as a light emitting section without a problem as long as the mass ratio is in the vicinity of 20:100 (however not exceeding 20:100), even though a light emitting section 5 with such a mass ratio would have its surface be decreased in flatness since a large part of fluorescent material would be exposed. In a case where the surface of the light emitting section requires to be flat, it is preferable to have the mass ratio be not more than 15:100.

In a case where the light emitting section 5 is prepared to have a range in mass ratio of not less than 1.0:100 to not more than 15:100, for example with a mass ratio of 3:100, 5:100, or 7:100, it is possible to prepare a light emitting section 5 which have no problems in dispersiveness, unevenness, surface state and the like. Hence, by preparing the light emitting section 5 in this range (1:100 to 15:100) in accordance with a preferable color temperature and chromaticity, it is possible to achieve in a high yield a light emitting section with high efficiency, excellent shape reproducibility, and like property.

A variance ratio of fluorescent material to sealing material gives effect on heat generation efficiency (i.e. heat release efficiency, from an opposite point of view) of the light emitting section. If the light emitting section is made of 100% fluorescent material, the generation of heat of the light emitting section increases, thereby quickening the deterioration of the light emitting section. By sealing the light emitting section with an appropriate amount of sealing material, it is possible to prevent the generation of heat of the fluorescent material.

As such, by appropriately setting the mixture ratio of the fluorescent material to the sealing material, it is possible to increase the light emission efficiency and heat resistance of the light emitting section 5.

(Composition of Fluorescent Material)

An example of the oxynitride fluorescent material that can be used in the light emitting section 5 is one commonly known as SiAlON fluorescent material. SiAlON fluorescent material is a substance in which in silicon nitride, a portion of silicon atoms is substituted with aluminum atoms, and a portion of nitrogen atoms is substituted with oxygen atoms. These can be prepared by dissolving, in silicon nitride (Si₃N₄), alumina (Al₂O₃), silica (SiO₂), rare earth elements and the like.

The oxynitride fluorescent material and nitride fluorescent material have a relatively high stability as compared to other fluorescent material. Accordingly, even if glass powder is mixed with the fluorescent material and this mixture is treated with heat when preparing a wavelength conversion member, the oxynitride fluorescent material and nitride fluorescent material is stably present in the glass. Hence, it is possible to attain a wavelength conversion member having a high luminous efficiency as a result.

Examples of the nitride fluorescent material encompass CASN (CaAlSiN₃) fluorescent material and SCASN ((Sr, Ca)AlSiN₃) fluorescent material. As described later, the SCASN fluorescent material has lower heat resistance than that of the CASN fluorescent material, however is characteristic in that a light emitting peak wavelength is shorter in wavelength.

The light emitting section 5 is, for example, a mixture of (i) low melting glass containing SiO₂, B₂O₃, and ZnO in a ratio of 2:2:1, (ii) Caα-SiAlON:Ce, and (iii) CASN:Eu, in a weight ratio of 10:2:1.

Another suitable example of the fluorescent material is nanoparticle fluorescent material using nanometer-sized particles of III-V compound semiconductors.

One feature of the nanoparticle fluorescent material is that even in a case where just a single type of compound semiconductor (e.g., GaN) is used, it is possible to change its luminous color by quantum size effect, by changing its particle size to nanometer size. For instance, InP emits red light when the particle size is around 3 nm to 4 nm. In the embodiment, the particle size is evaluated with a transmission electron microscope (TEM).

Moreover, since the fluorescent material is semiconductor-based, the fluorescence duration is short. However, power of the excitation light can be emitted rapidly as fluorescence, so therefore the fluorescent material is highly resistant against high-powered excitation light. This is because the light emission duration of the semiconductor nanoparticle fluorescent material is around 10 nanoseconds, which duration is five digits smaller than that of regular fluorescent material which has the rare earths serve as a luminescence center.

Furthermore, as described above, since the light emission duration is short, it is possible to quickly repeat absorption of the laser beam and light emission of the fluorescent material. As a result, a high efficiency is maintained with respect to strong excitation light, and generation of heat from the fluorescent material is held down.

Hence, it is possible to further prevent the light emitting section 5 from deteriorating (discoloring or deformation) caused by heat. Accordingly, in a case where a light emitting element having high optical output is used as a light source, it is possible to prevent the life of the light emitting device from shortening.

<Configuration of Laser Diode 2>

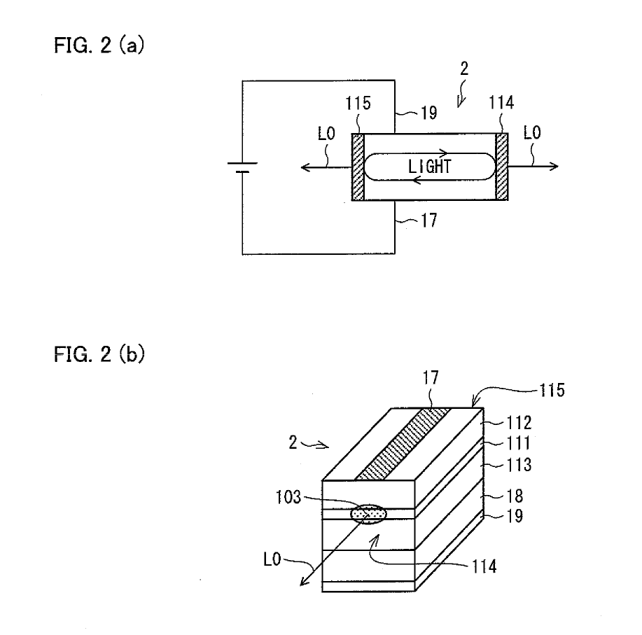

Next described is a basic configuration of the laser diode 2. FIG. 2(a) schematically illustrates a circuit of the laser diode 2, and FIG. 2(b) is a perspective view of the basic configuration of the laser diode 2. As illustrated in FIG. 2(b), the laser diode 2 is made up by stacking a cathode electrode 19, a substrate 18, a clad layer 113, an active layer 111, a clad layer 112, and an anode electrode 17 in this order.

The substrate 18 is a semiconductor substrate, and in order to obtain a blue to ultraviolet excitation light for exciting fluorescent material as in the present application, it is preferable to use GaN, sapphire, or SiC as the substrate 18. Generally, other examples of a substrate for use as a laser diode encompass substrates made of material such as: IV semiconductors such as Si, Ge, and SiC; III-V compound semiconductors represented by GaAs, GaP, InP, AlAs, GaN, InN, InSb, GaSb, and AlN; II-VI compound semiconductors such as ZnTe, ZeSe, ZnS, and ZnO; oxide insulators such as ZnO, Al₂O₃, SiO₂, TiO₂, CrO₂, and CeO₂; and nitride insulators such as SiN.

The anode electrode 17 is provided for injecting current into the active layer 111 via the clad layer 112.

The cathode electrode 19 is provided for injecting current into the active layer 111 via the clad layer 113 from under the substrate 18. The current is injected by applying a forward bias to the anode electrode 17 and the cathode electrode 19.

The active layer 111 is sandwiched between the clad layer 113 and the clad layer 112.

In order to obtain a blue to ultraviolet excitation light, a mixed crystal semiconductor including AlInGaN is used as the material of the active layer 111 and the clad layer 113. Generally, a mixed crystal semiconductor whose main component is Al, Ga, In, As, P, N, or Sb is used as the active layer and clad layers of the laser diode, and the configuration may be as such. Moreover, the active layer 111 and the clad layer 113 may be made up of a II-VI compound semiconductor such as Zn, Mg, S, Se, Te, or ZnO.

The active layer 111 is a region which emits light upon the injection of the current. The light emitted is trapped within the active layer 111 due to the difference in refractive index between the clad layer 112 and the clad layer 113.

Furthermore, the active layer 111 is formed so as to have a front cleaved plane 114 and a rear cleaved plane 115 which are disposed facing each other to trap the light amplified by stimulated emission. The front cleaved plane 114 and rear cleaved plane 115 serve as mirrors.

However, different from a mirror which completely reflects light, a portion of the light amplified by the stimulated emission is emitted from the front cleaved plane 114 and the rear cleaved plane 115 (in the embodiment, referred to as front cleaved plane 114 for convenience) of the active layer 111, and this emitted light serves as the laser beam L0, Note that the active layer 111 may be of a multilayer quantum well structure.

The rear cleaved plane 115 facing the front cleaved plane 114 has a reflective film (not illustrated) provided thereon, which reflective film is used for laser emission. By providing a difference in reflectance between the front cleaved surface 114 and the rear cleaved surface 115, it is possible to have most of the laser beam L0 be emitted from a low-reflectance edge plane, for example the front cleaved plane 114 via the light emitting point 103.

The clad layer 113 and the clad layer 112 may be made up of a semiconductor of any one of III-V compound semiconductors represented by GaAs, GaP, InP, AlAs, GaN, InN, InSb, GaSb, and AlN and II-VI compound semiconductors such as ZnTe, ZeSe, ZnS, and ZnO, each of which are of a n-type and a p-type. By applying a forward bias to the anode electrode 17 and the cathode electrode 19, current can be injected into the active layer 111.

Film formation of the semiconductor layers such as the clad layer 113, clad layer 112, and active layer 111, may be carried out by a general film forming method such as MOCVD (metal-organic chemical vapor deposition), MBE (molecular beam epitaxy), CVD (chemical vapor deposition), laser ablasion, sputtering, or like method. The film formation of the metal layers may be carried out by a general film forming method such as vacuum deposition, plating, laser ablasion, sputtering or like methods.

<Light Emitting Principle of Light Emitting Section 5>

Next described is a light emitting principle of the fluorescent material, which light emission is caused by the laser beam emitted from the laser diode 2.

First, the laser beam emitted from the laser diode 2 is emitted to the fluorescent material included in the light emitting section 5. This causes electrons existing inside the fluorescent material to be excited from a low energy state to a high energy state (excited state).

Since this excited state is unstable, the energy state of the electrons inside the fluorescent material thereafter switches back to the original low energy state (ground level energy state or metastable level energy state between excitation level and ground level) after elapse of a set time.

As such, the fluorescent material emits light upon a transition of the electrons excited to the high energy state back to the low energy state.

White light can be made up by a mixture of three colors which meet an isochromatic principle or by a mixture of two colors which are complementary colors for each other. By combining, based on these principles, the color of the light emitted from the laser diode with the color of light emitted from the fluorescent material as described above, it is possible to emit white light.

### Experiment Example 1

The following description explains an experiment result related to a spectrum of light emitted from the light emitting section 5.

(Emission Spectrum)

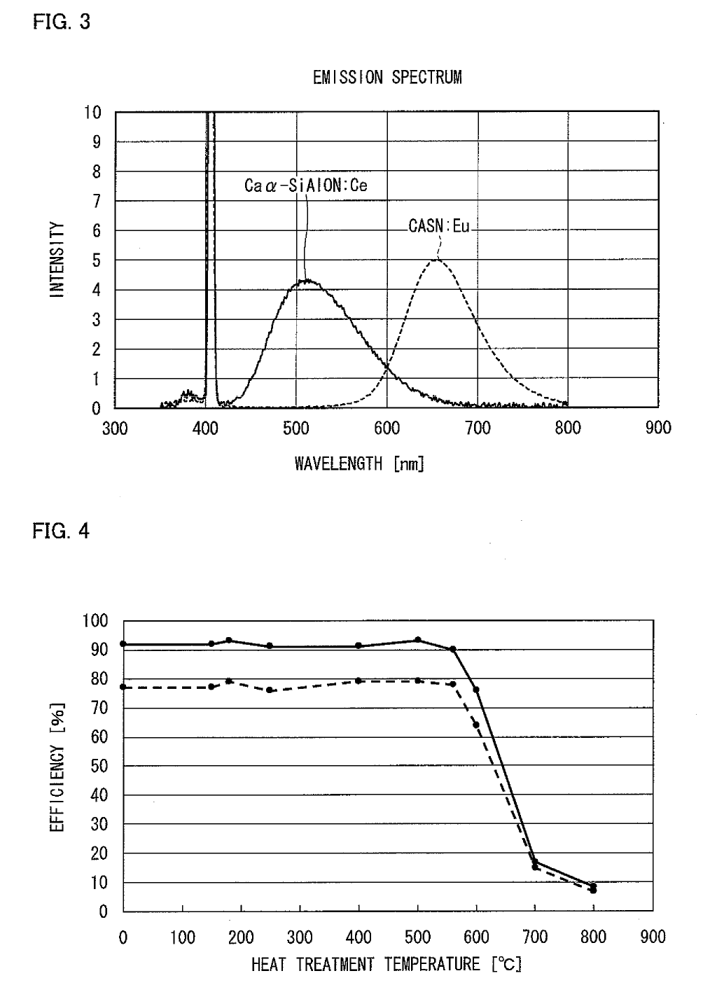

FIG. 3 is a view illustrating an emission spectrum in a case where Caα-SiAlON:Ce and CASN:Eu is used as the fluorescent material. The horizontal axis of the graph shows a wavelength of the light emitted from the fluorescent material, and the vertical axis shows intensity of the light.

As the sealing material of the light emitting section 5, low melting glass containing SiO₂, B₂O₃, and ZnO in a ratio of 2:2:1 was used. The low melting glass, Caα-SiAlON:Ce, and CASN:Eu were mixed in a weight ratio of 30:3:1, and this mixture was heated and melted to form a cylindrical light emitting section 5 (having a diameter of 3.5 mm and a thickness of 2 mm).

A laser beam emitted from the laser diode 2 which has an output of 1 W was made into a conical beam having a diameter of 3.5 mm with use of the aspherical lens 3, and the light emitting section 5 was irradiated with this laser beam. The irradiation light intensity was 0.1 W/mm². In this experiment, the light guiding section 4 was not used.

The emission spectrum was measured; as a result, Caα-SiAlON:Ce obtained a spectrum with a peak of approximately 507 nm. Moreover, CASN:Eu obtained a spectrum with a peak of approximately 650 nm.

The low melting glass of the present embodiment allows for attaining an effect that a glass transition point and a sintering temperature are decreased while the glass is stabilized, and further that transparency of the glass is maintained, by adding ZnO into the borosilicate glass.

By dispersing into the foregoing sealing material the SiAlON fluorescent material that is oxynitride fluorescent material and CASN fluorescent material that is nitride fluorescent material, it was possible to obtain a fluorescent material light emitting section which is difficult to deteriorate even if the fluorescent material light emitting section is excited with a laser beam.

### Experiment Example 2

The following describes an experiment related to heat resistance of a light emitting section 5 which was formed by dispersing SCASN fluorescent material into glass material.

SCASN fluorescent material is fluorescent material further containing Sr (strontium) in the CASN fluorescent material, and is a type of nitride fluorescent material. SCASN fluorescent material is considered as inferior as compared to CASN fluorescent material in terms of heat resistance, due to the effect of Sr. Note that SiAlON fluorescence is harder than CASN fluorescent material in terms of crystal, and is considered as higher in heat resistance than that of CASN fluorescent material.

Hence, in terms of heat resistance, the following relation is established: SiAlON fluorescent material>CASN fluorescent material>SCASN fluorescent material. Hence, it is thought that a temperature which is tolerable by the SCASN fluorescent material would also be tolerable by the SiAlON fluorescent material and CASN fluorescent material.

(Experiment Method)

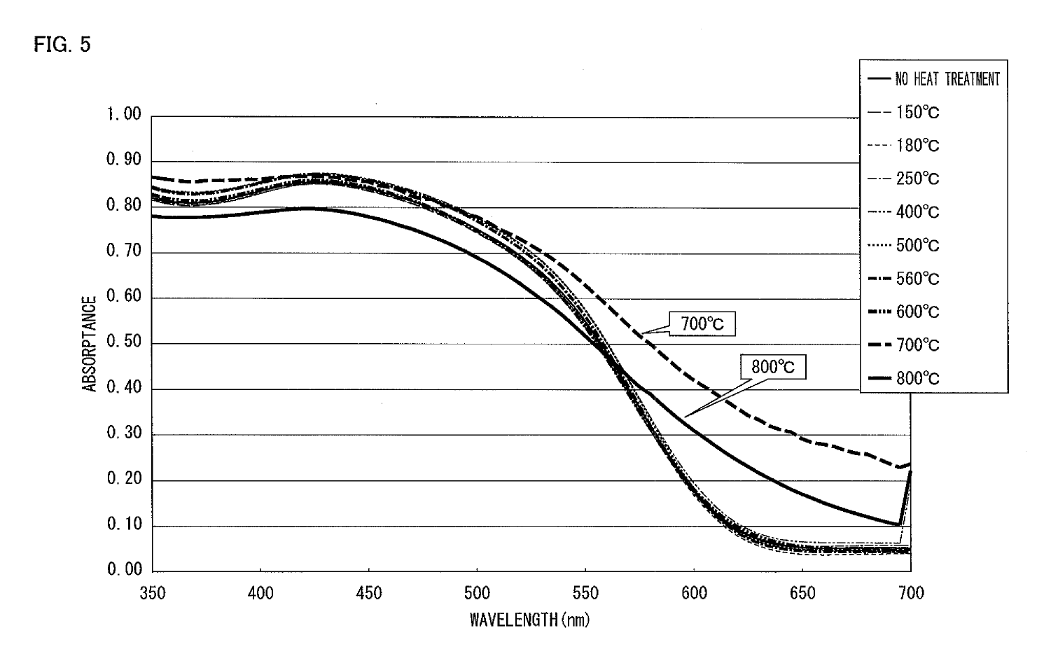

In an atmosphere, SCASN fluorescent material was increased in temperature to a predetermined temperature for 30 minutes, and was heated at that temperature for 30 minutes. Thereafter, internal and external quantum efficiency and absorptance were measured at room temperature. Such an experiment was carried out several times, each time with different heat treatment temperatures. Results of the experiments are as shown in FIG. 4 and FIG. 5.

(Experiment Result)

FIG. 4 is a graph illustrating a relationship of (i) the internal and external quantum efficiency of SCASN fluorescent material with (ii) the heat treatment temperature. The vertical axis of the graph denotes the quantum efficiency, and the horizontal axis of the graph denotes a treatment temperature at a time when the SCASN fluorescent material was treated with heat. Moreover, the solid line graph shows the change in the internal quantum efficiency, and the broken line in the graph shows the change in the external quantum efficiency.

As illustrated in FIG. 4, the result of the experiment at 0° C. shows the internal and external quantum efficiency of the SCASN fluorescent material in a case where no heat treatment was carried out. No effect caused by treating the SCASN fluorescent material with heat could be observed from the internal and external quantum efficiency in the experiment results until the heat-treatment temperature reached around 560° C. However, a further increase in the heat treatment temperature showed a remarkable decrease in the internal and external quantum efficiency.

From this fact, it can be said that with the heat-resistant fluorescent material used in the present invention, at least carrying out heat treatment within a temperature range from 0° C. to 560° C. would not cause a decrease in quantum efficiency that exceeds an error range, which quantum efficiency is measured at a certain temperature after the fluorescent material has been subjected to the heat treatment and is compared with the quantum efficiency measured at the certain temperature before the fluorescent material is subjected to the heat treatment.

FIG. 5 is a graph showing absorptance of light of different wavelengths, of fluorescent material which has been subjected to heat treatment. As illustrated in FIG. 5, light absorptance of light of the SCASN fluorescent material having different waveforms show no large difference from the light absorptance at room temperature (no heat treatment) until the heat treatment temperature reaches 600° C. However, a remarkable change was observed in at least a heat treatment temperature of 700° C. or more. More specifically, when the heat treatment temperature reached 700° C. and 800° C., the light absorptance was clearly different from a case where a heat treatment of a lower temperature was carried out. From this result, it can be understood that the fluorescent material has changed in property.

From these experiment results, it was found that the heat-resistant temperature of the SCASN fluorescent material in the atmosphere was lower than 600° C. The cause for the deterioration of SCASN fluorescent material is thought to be the release of nitrogen that was contained in the SCASN fluorescent material. Hence, by carrying out the heat treatment in nitrogen, it is possible to prevent the nitrogen from being released from the SCASN fluorescent material, and hence could possibly prevent the decrease in luminous efficiency.

For instance, in the headlamp 1, there is a possibility that heat resistance of the light emitting section 5 is improved by filling a space formed by the reflecting mirror 6 and the transparent plate 7, and irradiating the light emitting section 5 with the laser beam in nitrogen gas.

<Effect of Headlamp 1>

As described above, with the headlamp 1, the deterioration of the light emitting section 5 is prevented without reducing the luminous flux of light emitted from the light emitting section 5. Hence, it is possible to attain a headlamp 1 having a long life while achieving a luminance required as a headlamp. Furthermore, since the light emitting section 5 has a long life, it is possible to reduce the trouble and cost required for replacing the light emitting section 5.

### Embodiment 2

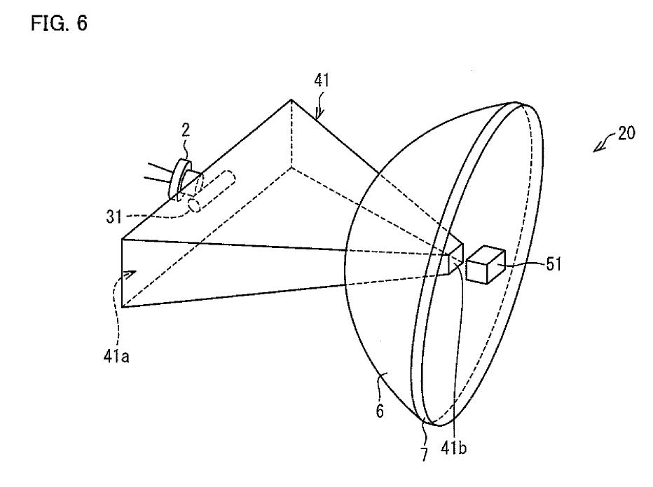

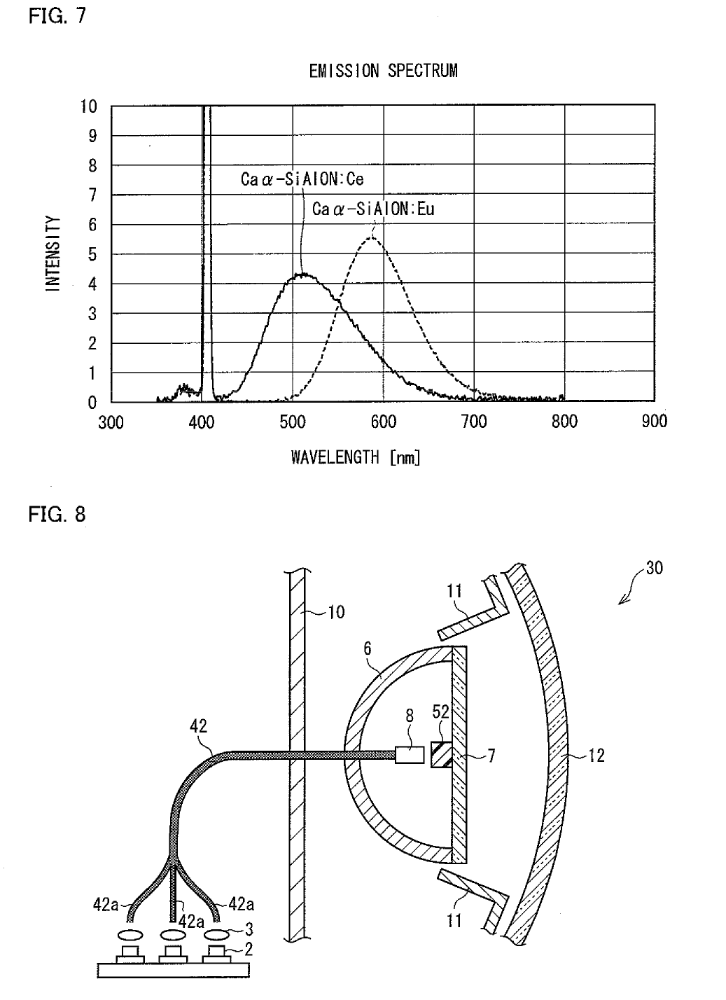

Another embodiment of the present invention is described below with reference to FIGS. 6 and 7. Note that, members same as those described in Embodiment 1 are provided with identical reference signs, and their descriptions have been omitted here.

FIG. 6 is a view schematically illustrating a configuration of a headlamp 20 according to the present embodiment. As illustrated in FIG. 6, the headlamp 20 includes, different from the headlamp 1, an aspherical lens 31 which is a rod lens, a light guiding section 41, and a light emitting section 51.

The light guiding section 41 is a light guiding member of a truncated pyramid shape which receives a laser beam emitted from the laser diode 2 on its light receiving surface 41a and which guides the laser beam to the light emitting section 51 by emitting the laser beam received from the light emitting surface 41b, and the light guiding section 41 is optically bound to the laser diode 2 via the aspherical lens 31. The light guiding section 41 uses same material as the light guiding section 4, and just the shape is different from the light guiding section 4. As with the light guiding section 4, the light guiding section 41 may be omitted from the configuration.

The light emitting section 51 is a cuboid having dimensions of height 1.2 mm×width 0.4 mm×depth 0.5 mm, and the light emitting section 51 differs from the light emitting section 5 in its shape. A light distribution pattern (light distribution) of a vehicle headlamp lawfully stipulated domestically in Japan is narrow in a vertical direction and broad in a horizontal direction; hence, in order to easily achieve the light distribution pattern, the shape of the light emitting section 51 is made wide in the horizontal direction (cross section being substantially rectangular shaped).

In the present embodiment, the light emitting section 51 is one in which Caα-SiAlON:Ce and Caα-SiAlON:Eu are used as the fluorescent material, and which the fluorescent material is dispersed in low melting glass to which BaO was added to a base of SiO₂, B₂O₃, and ZnO. By adding BaO to the low melting glass, it is possible to improve chemical durability, noncrystallinity and the like of the glass.

Moreover, in the present embodiment, the laser diode 2 has 10 stripes per chip (10 light emitting points per one chip), has an oscillation wavelength of 405 nm and an optical output of 10 W, is driven at an operation voltage of 5 V, an operation current of 6 A, and an electricity consumption of 30 W, and is mounted on a stem which has a diameter of 9 mm. In the embodiment, one of such a laser diode 2 is used, however a plurality of laser diodes 2 may be disposed along a long side of the light entering surface 41a of the light guiding section 41.

According to this configuration, even if the optical output of one laser diode 2 is small, it is possible to accomplish an excitation light source of a high output by use of a plurality of laser diodes 2.

### Experiment Example 3

The following describes an experiment result related to a spectrum of light emitted from the light emitting section 51.

FIG. 7 is a view illustrating an emission spectrum in a case where Caα-SiAlON:Ce and Caα-SiAlON:Eu are used as the fluorescent material. The horizontal axis of the graph shows a wavelength of light emitted from the fluorescent material, and the vertical axis shows intensity of the light.

Low melting glass containing SiO₂, B₂O₃, and BaO in a ratio of 2:2:1 was used as the sealing material. The low melting glass and the Caα-SiAlON:Ce and Caα-SiAlON:Eu were mixed in a weight ratio of 20:1:1 and this mixture was molded by hot-pressing, to form the light emitting section 51 of a cuboid shape (height 1.2 mm×width 0.4 mm×depth 0.5 mm).

The emission spectrum was measured, and Caα-SiAlON:Ce obtained a spectrum with a peak at approximately 507 nm. Moreover, Caα-SiAlON:Eu obtained a spectrum with a peak at approximately 585 nm.

The laser beam (output of 10 W) emitted from the laser diode 2 is shaped to have a height 1 mm×width 0.2 mm with use of the aspherical lens 31, and excites the light emitting section 51 with an optical density of 50 W/mm². In this experiment, the light guiding section 41 is not used.

The present embodiment allows for attaining, by use of an extremely stable oxynitride fluorescent material, a laser illumination light source in which the light emitting section does not deteriorate even upon excitation with a laser beam with high output and high optical density.

### Embodiment 3

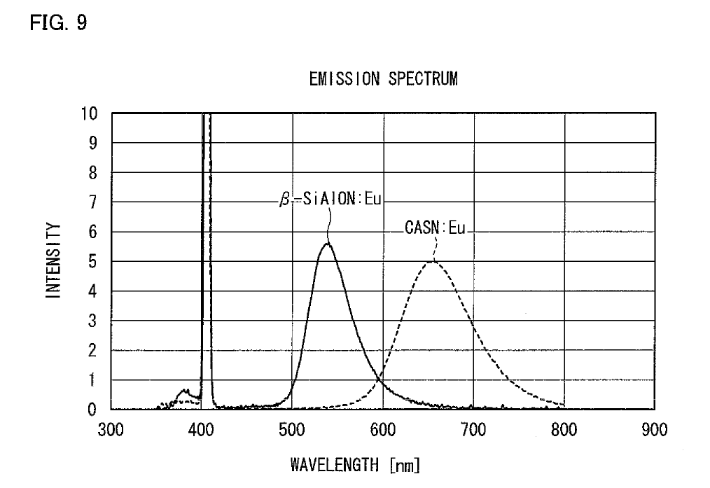

Another embodiment of the present invention is described below with reference to FIGS. 8 and 9. Note that, members same as those described in Embodiment 1 are with identical reference signs, and their descriptions have been omitted.

FIG. 8 is a view schematically illustrating a headlamp 30 according to the present embodiment. As illustrated in FIG. 8, the headlamp 30, different from the headlamp 1, includes twenty laser diodes 2, twenty aspherical lens 3, a light guiding section 42, a light emitting section 52, and an optical fiber fixture 8.

The laser diodes 2 are similar to the laser diode 2 of Embodiment 1, which has one light emitting point per chip and has an optical output of 1.0 W. Hence, light from a radiant flux of a total of 20 W is emitted from a plurality of laser diodes 2.

The light guiding section 42 is a bundle of the twenty optical fibers 42a, and is a light guiding member which guides the laser beams emitted from the twenty laser diodes 2 to the light emitting section 52 through respective optical fibers 42a. Note that as long as there are a same number of the laser diodes 2, the aspherical lenses 3, and the optical fibers 42a, the number is not limited to twenty.

The optical fiber 42a has a double-layered structure, which consists of (i) a center core and (ii) a clad which surrounds the core and has a refractive index lower than that of the core. The core is made mainly of fused quartz (silicon oxide), which has little absorption loss of the laser beam. The clad is made mainly of (a) fused quartz or (b) synthetic resin material, each of which having a refractive index lower than that of the core.

For example, the optical fiber 42a is made of quartz, and has a core of 200 μm in diameter, a clad of 240 μm in diameter, and a numerical aperture (NA) of 0.22. Note however that a structure, diameter, and material of the optical fiber 42a are not limited to those described above. A section of the optical fiber 42a perpendicular to a longitudinal direction of the optical fiber 42a can be a rectangular section.

The aspherical lens 3 causes the laser beams emitted from the laser diodes 2 to be entered from an entering end which is one end of the optical fiber 42a.

A coupling efficiency of the laser diode 2, the aspheric lens 3, and the optical fiber 42a (i.e. a ratio of an intensity of a laser beam emitted from an emitting end being another end of the optical fiber 42a, to an intensity of the laser beam from the laser diode 2) is 80%.

The emitting ends of the optical fibers 42 is bundled together by the optical fiber fixture 8, and a beam having a diameter of 5 mm is irradiated to the light emitting section 52. Therefore, the laser beams of a total of 20 W emitted from the laser diodes 2, once passed through the aspherical lens and the optical fiber, is outputted as laser beams having 16 W from the emitting ends of the optical fibers. An optical density of the beam at this time is 0.8 W/mm². The emitting end of the optical fiber 42a is determined in position with respect to the light emitting section 52 so that the laser beam emitted from the emitting ends are emitted to the light emitting section 52.

The light emitting section 52 is cylindrically shaped, having a diameter of 5.2 mm and a thickness of 1 mm. The light emitting section 52 is a member in which β-SiAlON:Eu and CASN:Eu as fluorescent material are dispersed in SiO₂—B₂O₃ low melting glass containing PbO.

In the headlamp 30, the optical fiber 42a is flexible, so it is easy to change the relative position of the laser diode 2 and the light emitting section 52. Moreover, by adjusting the length of the optical fiber 42a, it is possible to provide the laser diode 2 at a position away from the light emitting section 52.

This allows for increasing the freedom in design of the headlamp 30, such as disposing the laser diode 2 at a position easy to cool or easy to exchange.

### Experiment Example 4

The following describes an experiment result related to a spectrum of light emitted from the light emitting section 52.

FIG. 9 is a view illustrating an emission spectrum in a case where β-SiAlON:Eu and CASN:Eu are used as the fluorescent material. The horizontal axis of the graph shows a wavelength of the light emitted from the fluorescent material, and the vertical axis shows the intensity of the light.

As the sealing material, low melting glass containing SiO₂, B₂O₃, and PbO in a ratio of 2:2:1 was used. This low melting glass, β-SiAlON:Eu, and CASN:Eu were mixed in a mass ratio of 50:3:1, and were heated and melted by hot-press molding to form a cylindrical light emitting section 5 (diameter of 5.2 mm, thickness of 1 mm).

The light emitting section 5 was irradiated with the laser beam, of which β-SiAlON:Eu obtained a spectrum with a peak at approximately 540 nm. Moreover, CASN:Eu obtained a spectrum with a peak at approximately 650 nm.

In this Example also, it was possible to attain a fluorescent material light emitting section that can tolerate excitation of a high output and high optical density laser beam of an output of 20 W and an optical density of 0.94 W/mm².

### Embodiment 4

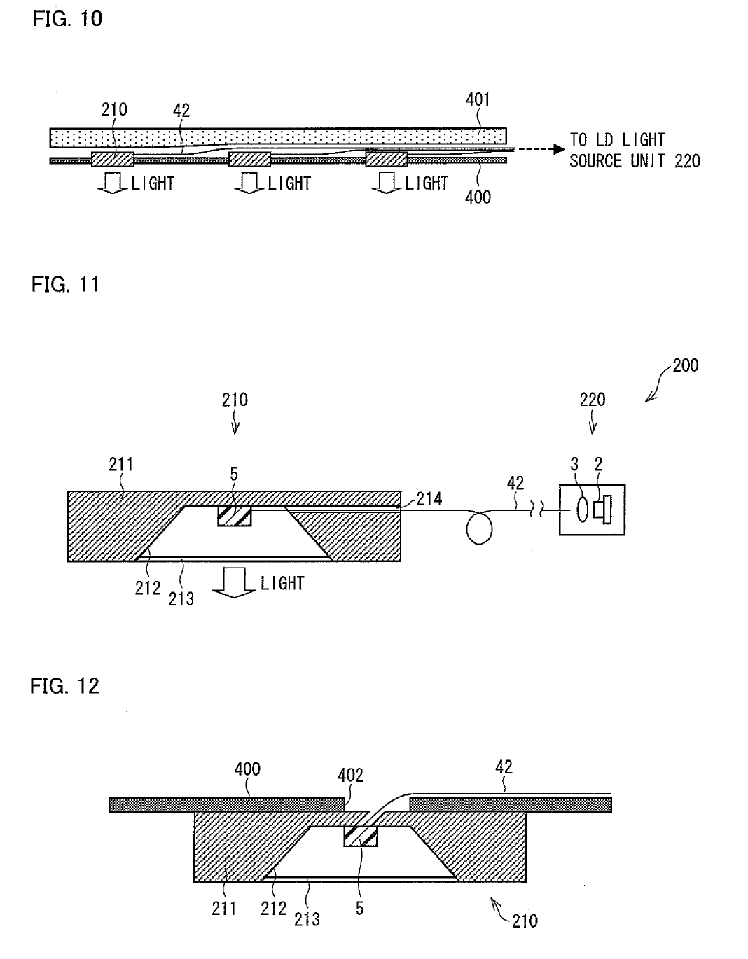

Another embodiment of the present invention is described below, with reference to FIGS. 10 through 12. Members in the present embodiment which are identical to those in Embodiments 1 through 3 are provided with identical reference signs, and their descriptions have been omitted.

This embodiment describes a laser downlight 200 as an example of an illuminating device of the present invention. The laser downlight 200 is an illuminating device which is disposed on a ceiling of a structure such as a building, vehicle or the like, and uses fluorescence as illumination light, which fluorescence is emitted upon irradiation of the light emitting section 5 with a laser beam emitted from the laser diode 2.

Moreover, an illuminating device having a similar configuration to the laser downlight 200 may be disposed on a side wall or a floor of the structure. Where the illuminating device is disposed is not particularly limited.

FIG. 10 is a cross sectional view of a ceiling on which the laser downlight 200 is disposed. FIG. 11 is a cross sectional view of the laser downlight 200. As illustrated in FIGS. 10 and 11, the laser downlight 200 is embedded in a top panel 400, and includes a light emitting unit 210 which emits illumination light and a light source unit 220 which supplies a laser beam to the light emitting unit 210 via the optical fiber 42. The light source unit 220 is not disposed on the ceiling, and is disposed on a position where the user can easily touch (e.g., side wall of building). The light source unit 220 can be freely positioned as such since the light source unit 220 and the light emitting unit 210 are connected to each other via the optical fiber 42. The optical fiber 42 is disposed in a gap between the top panel 400 and a heat insulating material 401.

(Configuration of Light Emitting Unit 210)

As illustrated in FIG. 11, the light emitting unit 210 includes a housing 211, the optical fiber 42, a light emitting section 5, and a light transmitting plate 213.

The housing 211 has a concave section 212, and the light emitting section 5 is disposed on a bottom surface of the concave section 212. The concave section 212 has a metal thin film formed on its surface, and therefore the concave section 212 functions as a reflecting mirror.

The housing 211 includes a path 214 formed to pass through the optical fiber 42; the optical fiber 42 passes through the path 214 and extends to the light emitting section 5. The relationship in position of the emitting ends 5a of the optical fiber 42 with the light emitting section 5 is the same as the relationship as described above.

The light transmitting plate 213 is a transparent or a semitransparent plate disposed so as to close an opening of the concave section 212. The light transmitting plate 213 functions similarly to the transparent plate 9; fluorescence emitted from the light emitting section 5 is emitted through the light transmitting plate 213 as illumination light. The light transmitting plate 213 may be detachable from the housing 211, or may be omitted from the configuration.

Different from the case of the headlamp, the downlight does not require an ideal point light source, and is sufficient just as having one light emitting point. Hence, restrictions regarding the shape, size and disposition of the light emitting section 5 are fewer than those of the headlamp.

(Configuration of LD Light Source Unit 220)

The LD light source unit 220 includes a laser diode 2, an aspherical lens 3, and an optical fiber 42.

The entering end 5b which is one end of the optical fiber 42 is connected to the light source unit 220. The laser beam emitted from the laser diode 2 enters the entering end 5b of the optical fiber 42 via the aspherical lens 3.

Just one pair of the laser diode 2 and the aspherical lens 3 is illustrated inside the light source unit 220 illustrated in FIG. 11. However, in a case where a plurality of light emitting units 210 are provided, a bundle of the optical fibers 42, each of which extends from a respective one of the light emitting units 210, may be guided to a single LD light source unit 220. In this case, a plurality of pairs of the laser diode 2 and the aspherical lens 3 (or a set of a plurality of laser diodes 2 and one rod-shaped lens 32) is to be stored in one light source unit 220, and the light source unit 220 is to function as a centralized power source box.

(Modification of Method of Disposing Laser Downlight 200)

FIG. 12 is a cross sectional view illustrating a modification of how the laser downlight 200 is disposed. As illustrated in FIG. 12, the modification of how the laser downlight 200 is disposed may be one in which the top panel 400 just has a small hole 402 opened for passing through the optical fiber 42, and the laser downlight itself (light emitting unit 210) is adhered to the top panel 400 with a strong adhesive tape or the like, with utilization of the thin and lightweight characteristics of the laser downlight 200. In this case, the restrictions for disposing the laser downlight 200 is reduced, and is also advantageous in that construction costs can be remarkably reduced in amount.

### Embodiment 5

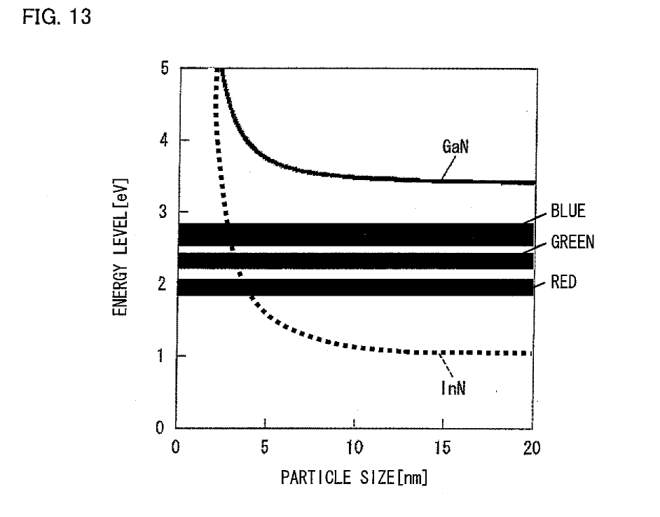

Described below is yet another embodiment of the present invention, with reference to FIG. 13. The present embodiment describes a modification of the light emitting section 5 disposed in the headlamp 1 described above. Members other than the light emitting section 5 are similar to those described above. Note that the present embodiment is also applicable to the light emitting section 51 of the headlamp 20 and the light emitting section 52 of the headlamp 30.

(Density of Fluorescent Material and Sealing Material)

<Case of Oxynitride Fluorescent Material or Nitride Fluorescent Material>

In a case where oxynitride fluorescent material or nitride fluorescent material is used as the fluorescent material of the light emitting section 5, that is, if an average particle size of the fluorescent material in the light emitting section 5 is not less than 1 μm however not more than 50 μm, a density of the fluorescent material contained in the light emitting section 5 is not less than 2.5 g/cm³ but not more than 4.0 g/cm³, and the density of the glass material as the sealing material is not less than 2.0 g/cm³ but not more than 7.0 g/cm³, more preferably not less than 2.0 g/cm³ but not more than 6.0 g/cm³.

If the fluorescent material is distributed in an unbalanced manner in the light emitting section 5, the part where the fluorescent material is close to each other excessively generates heat, which may cause deterioration of the light emitting section 5. Hence, when dispersing the fluorescent material in the sealing material, it is preferable to disperse the fluorescent material evenly in the sealing material.

As a result of diligent study, the inventor of the present invention found that to disperse the fluorescent material evenly in the sealing material (particularly glass material), it is important to have the fluorescent material and the sealing material be in appropriate densities. The densities of the fluorescent material and the glass material are ranges of preferable densities to evenly mix the two materials.

The ranges of the densities preferable for evenly mixing particles of material of two or more types (i.e. the fluorescent material and the sealing material) are relative; if the density of the fluorescent material changes, the density of the sealing material also inevitably changes. The foregoing density ranges are ones which a density range of the fluorescent material is fixed, and thereafter a preferable density range of the sealing material is obtained.

The density of silicon nitride (SiN) which serves as base of crystals of SiAlON fluorescent material that is one example of the oxynitride fluorescent material and CASN fluorescent material that is one example of the nitride fluorescent material, is 3.2 g/cm³. Hence, the densities of the SiAlON fluorescent material and CASN fluorescent material are values of around 3.2 g/cm³. This value is within the foregoing density range of the fluorescent material.

On the other hand, the density of YAG:Ce fluorescent material which is an extremely typical LED fluorescent material, is around 4.8 g/cm³. Other than this, the density of silicate fluorescent material is around 4.3 g/cm³, and the density of TAG fluorescent material is around 6 g/cm³. These values are excluded from the foregoing density range of the fluorescent material.

Namely, the foregoing density range of the fluorescent material corresponds to the density range of the oxynitride fluorescent material or nitride fluorescent material such as SiAlON fluorescent material or CASN fluorescent material, and in the case where the oxynitride fluorescent material or the nitride fluorescent material is used, it is possible to evenly mix the fluorescent material and sealing material by having the sealing material have the foregoing density range. An experiment example demonstrating this fact is described later.

<Case of Semiconductor Nanoparticle Fluorescent Material>

Moreover, in a case where semiconductor nanoparticle fluorescent material is used as the fluorescent material of the light emitting section 5, it is possible to use, for example, GaN, InN, and InGaN which is a mixed crystal of the two as the fluorescent material. An average particle size of the semiconductor nanoparticle fluorescent material is generally not more than 100 nm. Moreover, density of pure GaN is 6.10 g/cm³, and the density of InN is 6.87 g/cm³. The density of InGaN may be within the range of 6.0 g/cm³ to 7.0 g/cm³, more preferably 6.10 g/cm³ to 6.87 g/cm³, from its mixed crystal ratio and the contained amount of impurities.

A preferable average particle size of the semiconductor nanoparticle fluorescent material is not more than 50 nm, is more preferably not more than 10 nm, and is further more preferably not more than 5 nm. The reason for this is described with reference to FIG. 13.

FIG. 13 is a graph illustrating a relationship of an average particle size of semiconductor nanoparticle fluorescent material (GaN and InN) with fluorescence wavelength. In FIG. 13, the horizontal axis shows a particle size of the semiconductor nanoparticle fluorescent material, and the vertical axis shows an energy level of the semiconductor nanoparticle fluorescent material. In the graph, a relationship between particle size and energy level related to GaN is shown by the solid line, and the relationship between particle size and energy level related to InN is shown by the broken line. Moreover, the regions provided with words of blue, green, or red, roughly show respective energy levels of emission of blue, green, or red light. The particle size in an intersection of the regions showing blue, green, and red, and the curve in the graph indicate a particle size which emits light of that color. For example, in the case of InN, red fluorescence is emitted when the particle size is 5 nm.

As shown in FIG. 13, in the case of InN, visible light is efficiently generated with a particle size in a range of not less than 2 nm to not more than 5 nm. Moreover, with GaN, although it is not possible to generate visible light, semiconductor nanoparticle fluorescent material of various average particle sizes may be generated by mixing crystals of the GaN and InN, and by controlling the particle size of the semiconductor nanoparticle fluorescent material, it is possible to obtain semiconductor nanoparticle fluorescent material which can emit light having a target wavelength.

The range of the particle size which generates visible light differs for each semiconductor nanoparticle fluorescent material, however in average, visible light is more efficiently generated in a case where the average particle size is not more than 50 nm, and furthermore, visible light is generated with high efficiency as the average particle size is reduced, to not more than 10 nm and further not more than 5 nm.

Hence, it is preferable that the average particle size of the semiconductor nanoparticle fluorescent material is not more than 50 nm, more preferably not more than 10 nm, and further preferably not more than 5 nm. However, the lower limit value is greater than 0.

In a case where fluorescent material having a particle size of nanometer order such as the semiconductor nanoparticle fluorescent material is evenly mixed with glass powder which has a particle size 100 to 10,000 times larger than the particle size of the fluorescent material, it is possible to disperse the fluorescent material evenly even if the density range of the glass is broader than that of a case where the glass is mixed with the oxynitride fluorescent material. Hence, in a case where the semiconductor nanoparticle fluorescent material is used as the fluorescent material of the light emitting section 5, that is, if the average particle size of the fluorescent material is not more than 50 nm, the density of the glass material is not less than 2.0 g/cm³ but not more than 12.0 g/cm³, more preferably not less than 6.0 g/cm³ but not more than 11 g/cm³.

This density range is obtained by fixing the density range of the semiconductor nanoparticle fluorescent material then obtaining a preferable density range of the sealing material. In the case where the semiconductor nanoparticle fluorescent material is used as the fluorescent material of the light emitting section 5, the fluorescent material and the sealing material may be evenly mixed by having the density range of the sealing material be in the foregoing range.

The density of GaN which is an example of the semiconductor nanoparticle fluorescent material is 6.1 g/cm³, and this range is within the density range of the fluorescent material.

(Particle Size of Fluorescent Material and Sealing Material)

In a case where the light emitting section 5 is formed by mixing the fluorescent material powder with the sealing material powder (particularly, glass powder) and thereafter having this mixture be subjected to heat treatment, it is preferable that the fluorescent material powder and the sealing material powder have closer average particle sizes, since this makes it easier to mix the fluorescent material powder and the sealing material powder together evenly.

More specifically, with an oxynitride fluorescent material or nitride fluorescent material whose powder has an average particle size from 1 μm to 50 μm, it is preferable that the average particle size of the glass powder is larger than 0 μm but not larger than 350 μm. However, if the particle size of the glass powder is too small, bubbles may remain after carrying out the heat treatment. In view of this, it is preferable that the average particle size of the glass powder is not smaller than 1 μm but not larger than 350 μm.

Moreover, in view of luminous efficiency of fluorescent material, a preferable range of the particle size of the powder of oxynitride fluorescent material or nitride fluorescent material is not smaller than 10 μm but not larger than 40 μm, and a more preferable range of the particle size of the glass powder is, as with the preferable range of the particle size of the fluorescent material, not smaller than 10 μm but not larger than 40 μm.

Moreover, as described above, a preferable average particle size of the semiconductor nanoparticle fluorescent material is larger than 0 but not larger than 50 nm. A preferable average particle size of the glass powder corresponding to the average particle size of the semiconductor nanoparticle fluorescent material is not smaller than 1 μm but not larger than 10 μm. If the average particle size of the glass powder is smaller than 1 μm, more bubbles remain. Moreover, if the average particle size of the glass powder is larger than 10 μm, the difference in particle size between the glass powder and the semiconductor nanoparticle fluorescent material become too large, thereby causing the semiconductor nanoparticle fluorescent material to be present in a void between a glass powder and another glass powder. This makes it difficult to disperse the semiconductor nanoparticle fluorescent material evenly.

As such, in addition to the densities of the fluorescent material and the sealing material being within a predetermined range, by having a difference between average particle sizes of the powders be within a predetermined range, it is possible to evenly mix together the two materials.

If a large and special mixing device is used for the mixing, it is not impossible to evenly mix the two even if the density or particle size of the fluorescent material and sealing material do not satisfy the foregoing conditions. Meanwhile, the present invention provides a method of evenly mixing the two materials easily without using such a special mixing device or a special mixing method, and provides a wavelength conversion member as its produced product.

(Mixed Ratio of Fluorescent Material and Sealing Material)

It is preferable that the mixture ratio of the fluorescent material powder and the glass powder is within a range of 30:70 to 50:50 in mass ratio.

Generally, with a wavelength conversion member in which fluorescent material is sealed with transparent material such as silicone resin or glass, if the fluorescent material density is too low in the transparent material, it becomes difficult to sufficiently emit light, whereas if the fluorescent material density is too high, it becomes difficult to irradiate the fluorescent material with the excitation light. By having a mixture ratio of the fluorescent material powder to glass powder as 30:70 to 50:50 in mass ratio, it is possible to sufficiently irradiate the fluorescent material.

### Example

Described below is an example of a specific method of producing the light emitting section 5 by mixing the fluorescent material and the sealing material.

CASN:Eu and Ca-α-SiAlON:Ce, each having an average particle size of 20 μm, were used as the fluorescent material powder. The density of the CASN:Eu and Ca-α-SiAlON:Ce were, as described above, around 3.2 g/cm³.

As the glass powder, glass (SiO₂—B₂O₃—CaO—BaO—Li₂O—Na₂O) having a softening point at 500° C., which glass contains boric acid in its composition, has a density of 3.18 g/cm³, and has an average particle size of 20 μm was used.

These powders were weighed so that the mixed ratio of the glass powder to the fluorescent material powder were (glass powder):(CASN:Eu):(Ca-α-SiAlON:Ce)=7:1:2, in mass ratio. Furthermore, these powders were mixed so that they were mixed together evenly (mixing step). The mixing was carried out by placing the measured glass powder and fluorescent material into a container and shaking this container.

The average particle size and density of the glass powder and the average particle size and density of the fluorescent material powder were made substantially equal for the following reasons. If powders having a small density and a high density were mixed together, the two would separate in vertical directions, thereby making it difficult to mix together evenly. Furthermore, if powders having a small particle size were to be mixed with powders having a large particle size, the two would separate in vertical directions, which would also be difficult to mix together evenly.

In view of these points, it is preferable that the average particle size of the glass powder is larger than 0 μm but not larger than 350 μm. A further more preferable range is not smaller than 1 μm but not larger than 200 μm. Moreover, it is preferable that the density of the glass powder is in a range from 2.0 g/cm³ to 7.0 g/cm³. A further more preferable range is from 2.0 g/cm³ to 6.0 g/cm³.

The mixed powder obtained as a result was put into a metal die and was treated with heat at 560° C. for 0.5 hours (heat treatment step), to prepare the wavelength conversion member (light emitting section 5).

By having the glass powder and the fluorescent material powder be evenly mixed together before carrying out the heat treatment, it is possible to prepare a wavelength conversion member in which the fluorescent material contained in the glass is evenly dispersed, which wavelength conversion member is obtained after being subjected to heat treatment. In the present Example, the heat treatment is carried out at a temperature around the glass softening point. Hence, the glass will not completely melt. This prevents the fluorescent material from precipitating, which precipitation occurs in a case of carrying out heat treatment to a mixture of sealing material such as silicone resin or epoxy resin and the fluorescent material. Moreover, even if the heat treatment were carried out with a higher temperature than the glass softening point at a temperature at which the glass would completely melt, the densities of the glass powder and the fluorescent material are made substantially equal. Hence, it would be difficult for the precipitation of the fluorescent material to occur which precipitation is caused by the difference in density of glass and fluorescent material powder at the time of melting the glass powder. Accordingly, it is possible to obtain a wavelength conversion member in which the fluorescent material is dispersed into glass uniformly.

Moreover, an organic binder is not used when carrying out heat treatment to the glass powder and the fluorescent material powder. Therefore, it is possible to prevent the decrease in the quality of the wavelength conversion member caused by insufficient removal of the organic binder.

<Effect of Headlamp 1>

As described above, in the light emitting section 5 of the present embodiment, the density of the fluorescent material is not less than 2.5 g/cm³ but not more than 4.0 g/cm³, and the density of the sealing material is not less than 2.0 g/cm³ but not more than 7.0 g/cm³, more preferably not less than 2.0 g/cm³ but not more than 6.0 g/cm³. Hence, it is possible to evenly disperse the fluorescent material into glass, which is sealing material, and improve the use efficiency of the excitation light.

Moreover, since the fluorescent material is evenly dispersed in the glass, there is a lower possibility that local deterioration of the wavelength conversion member would occur, which allows for accomplishing a wavelength conversion member having high long-term reliability.

### Embodiment 6

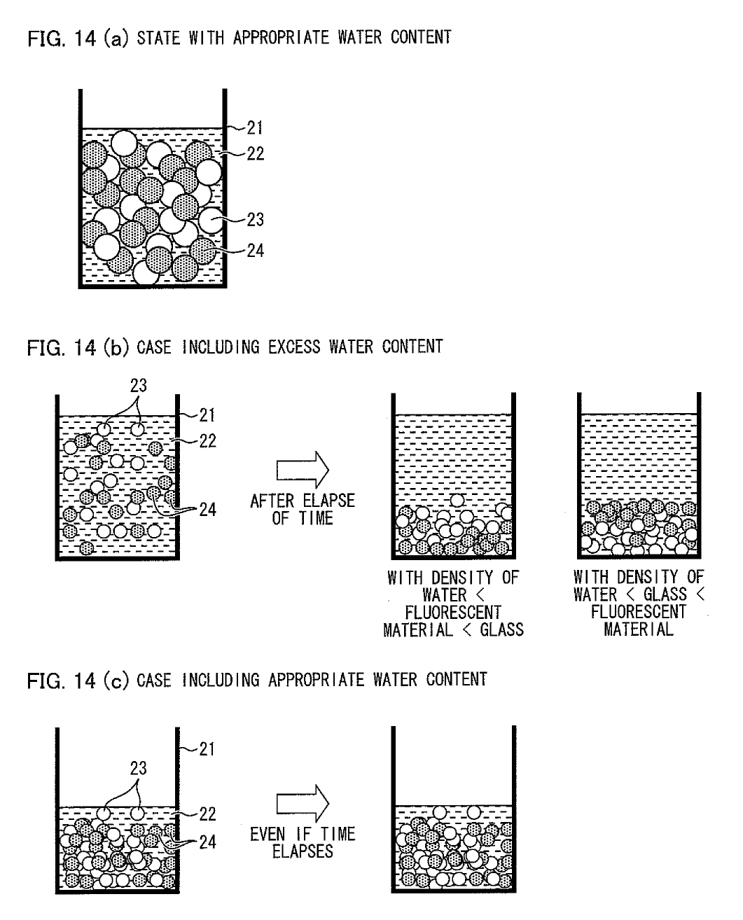

Described below is another embodiment of the present invention, with reference to FIGS. 14(a) through 14(c).

The present embodiment describes an example of a different method of mixing the fluorescent material and the sealing material. A light emitting section (wavelength conversion member) 5 produced with use of this mixing method is applicable as the light emitting section of the light emitting device and illuminating device as described in Embodiments 1 through 4. Note that members other than the light emitting section 5 are similar to those as described above.

In the present embodiment, the fluorescent material and sealing material having the average particle size and density as shown in Embodiment 5 are mixed by adding a liquid as a dispersion medium to mix the fluorescent material and sealing material, to more disperse the fluorescent material and sealing material more evenly.

(Types of Dispersion Medium)

Water or an organic solvent may be used as the dispersion medium. It is preferable to change the type of dispersion medium depending on the type of the fluorescent material.

More specifically, if the fluorescent material is the oxynitride fluorescent material or the nitride fluorescent material, it is preferable that the dispersion medium is water, and more preferably pure water. Water has no inflammability, so therefore handling of it is easy, and also water is non-toxic and thus is safe. Moreover, pure water can be purified from city water by a simple device so therefore is easily obtainable. Furthermore, water does not react with the fluorescent material since it does not contain impurities. This prevents the deterioration in features of the fluorescent material.

The reasons are as described below. It was found that in the case where oxynitride fluorescent material or nitride fluorescent material was used as the fluorescent material of the light emitting section, use of an organic solvent as the dispersion medium in the mixing step of these fluorescent materials would cause a problem that the light emitting section obtained after carrying out the heat treatment would blacken and its luminous efficiency would decrease. However, if water were used as the dispersion medium, no such blackening occurs, and no decrease in luminous efficiency was observed. Hence, it is preferable that the dispersion medium to be added when mixing the sealing material with the oxynitride fluorescent material or nitride fluorescent material is water. Note that this problem and solution were found out by the inventor of the present invention.

Moreover, if the fluorescent material is sulfide fluorescent material, it is preferable that the dispersion medium is a liquid containing water by 0.5% by volume or less.

The reason for this is as described below. When sulfide fluorescent material was in contact with water, the luminous efficiency of the sulfide fluorescent material decreased. However, if a medium not containing water (e.g. organic solvent) was used as the dispersion medium, such a decrease in luminous efficiency was not recognized. Hence, it is preferable that the dispersion medium added when mixing the sulfide fluorescent material and the sealing material is a liquid containing water by 0.5% by volume or less. Note that this problem and solution were found by the inventor of the present invention.

Examples of such liquid include dehydrated ethanol, methanol, isopropyl alcohol, and MIBK (methyl isobutyl keton). Note that acetone, which is often used as an organic solvent, is not preferable since (i) its flash point is low, so therefore is more dangerous as compared to the foregoing liquids, and (ii) is highly volatile and evaporates while mixing the fluorescent material and the sealing material, thereby making it difficult to achieve the effect for mixing evenly.

The density of the sulfide fluorescent material is preferably, as with the oxynitride fluorescent material and nitride fluorescent material, not less than 2.5 g/cm³ but not more than 4.0 g/cm³. Moreover, it is preferable that the sulfide fluorescent material has an average particle size of not smaller than 1 μm but not larger than 50 μm.

(Added Amount of Dispersion Medium)

FIGS. 14(a) through 14(c) are views for describing preferable added amounts of the dispersion medium. There is a preferable range of an added dispersion medium content when mixing the fluorescent material and the sealing material together. The following describes an example where water is used as the dispersion medium and glass is used as the sealing material.

FIG. 14(a) is a view illustrating a state in which the fluorescent material particles 23 and the glass particles 24 are evenly dispersed in water 22 inside a container 21. The container 21 is a container used for mixing the fluorescent material particles 23 and the glass particles 24, or is a die to be used when treating the mixture of the fluorescent material particles 23 and the glass particles 24 with heat.

As illustrated in FIG. 14(a), it is preferable that the fluorescent material particles 23 and the glass particles 24 are dispersed evenly in the water 22. With such a state, it is possible to achieve a state in which the fluorescent material particles 23 are dispersed evenly in the glass particles 24 as a result.

By stirring the mixture of the water 22, the fluorescent material particles 23, and the glass particles 24, a state in which the fluorescent material particles 23 and the glass particles 24 are evenly dispersed in the water 22 is obtained temporarily, however whether or not the evenly dispersed state would be maintained for a long time or whether the distribution would become unbalanced in a short time tends to be determined based on the added amount of the water 22.

More specifically, as illustrated in FIG. 14(b), if the relative amount of the water 22 is great with respect to the fluorescent material particles 23 and the glass particles 24, the mixture precipitates on the bottom of the container 21 as time elapses after the mixture is stirred. At this time, of the fluorescent material particles 23 and the glass particles 24, the particles having a greater density precipitates on the bottom side of the container 21. As a result, the distribution of the particles in the mixture of the fluorescent material particles 23 and glass particles 24 becomes unbalanced, thereby causing the distribution of the fluorescent material in the sealing material to be unbalanced in the produced light emitting section.

On the other hand, as illustrated in FIG. 14(c), if the relative amount of the water 22 with respect to the fluorescent material particles 23 and the glass particles 24 is of an appropriate amount, an evenly dispersed state of both particles is maintained, without the distribution of the fluorescent material particles 23 and glass particles 24 in the mixture becoming unbalanced even after an elapse of time since the mixture is stirred.

As such, it is preferable that the added amount of liquid as the dispersion medium is an amount in which the fluorescent material particles 23 and the glass particles 24 are dispersed evenly in a stable manner.

If the density of the fluorescent material particles 23 or glass particles 24 is close to the density of the dispersion medium, the particles present in an upper part (opposite to a part closer to the bottom of the container 21) may be floating inside the dispersion medium after the mixture has been stirred. Even in such a case, the dispersion medium is removed in the latter step, so as long as the fluorescent material particles 23 and the glass particles 24 are floating evenly, the distribution of the fluorescent material and the sealing material in the produced light emitting section would be even.

The amount of dispersion medium which allows for distributing the fluorescent material particles 23 and the glass particles 24 evenly, in the dispersion medium, is an amount adjusted so that the dispersion medium, the fluorescent material particle and the sealing material particle become a sol-form (mud state) which is viscous.

More specifically, a preferable added amount of the dispersion medium is an amount which fills a space (void) between the fluorescent material particles 23 and the glass particles 24. In a case where the fluorescent material particles 23 and the glass particles 24 have a same diameter and the shape of the particles are spherical, a void rate is 26% and a filling rate is 74% when these two particles are filled in a closely packed manner.

In a case where a mixture of the fluorescent material particles 23 and the glass particles 24, each of which having a density of 3 g/cm³, is prepared and 1 g of this mixture is filled in a container in a closely packed manner, a volume attained of this mixture of the fluorescent material particles 23 and glass particles 24 present in the container is:

1 g÷(3 g/cm³)=0.33 cm³ (filling rate).

Hence, the volume of the void would be:

0.33×(26÷74)=0.12 cm³.

As from the above, a minimum value of the liquid to fill up the space is 0.12 ml per 1 g of the mixture of the fluorescent material particles and glass particles.

More specifically, a preferable added amount of the dispersion medium depends on (i) a difference in density between the dispersion medium, the fluorescent material particles 23 and the glass particles 24 and (ii) a difference in average particle sizes of the dispersion medium, the fluorescent material particles 23 and the glass particles 24. The appropriate amount of the dispersion medium differs for each of combinations thereof.

For example, with a combination of pure water as the dispersion medium and the fluorescent material particles 23 and glass particles 24, the appropriate amount of the dispersion medium is 0.5 ml of pure water to 1 g of mixed powder of the fluorescent material particles 23 and the glass particles 24.

(Effect of Adding Dispersion Medium)

By adding the dispersion medium to the mixture of the fluorescent material particles and sealing material particles, it is possible to evenly mix particles of a particle size not within the range of the average particle size, and can more evenly mix the fluorescent material particles and the sealing material particles. Namely, the difference in particle size of the fluorescent material particles and the sealing material particles may be buffered by the dispersion medium.

Moreover, adding the dispersion medium allows for maintaining the evenly mixed state while transferring the mixture of the fluorescent material particles and sealing material particles from a container that is used to mix the materials to another container (e.g. die for heat treatment). This is because vibration that occurs when the mixture moves is buffered by the dispersion medium; this vibration prevents the small-sized particles from precipitating downwards.

Moreover, adding the dispersion medium prevents generation of static electricity. Hence, it is possible to prevent the fluorescent material particles or the sealing material particles from scattering caused by the static electricity, or prevent the fluorescent material particles or the sealing material particles from adhering to the surface of a dispensing spoon, paper used for wrapping powdered medicine, a container or the like. This reduces the loss of the fluorescent material particles and sealing material particles, and makes it easier to strictly adjust (improve reproducibility of) a ratio of the fluorescent material and the sealing material in the light emitting section.

It actually has been confirmed that as a result of comparing a case where a dispersion medium is added (wet mixture) with a case where no dispersion medium is added (dry mixture), chromaticity reproduction of light emitted from the produced light emitting section is better in the wet mixture. This result is thought to be achieved since the fluorescent material particles which would be lost in the case of the dry mixture stay contained in the light emitting section, in the case of the wet mixture.

(Production Example 1 of Light Emitting Section)

Next describes a specific example of producing a light emitting section by adding a dispersion medium to the fluorescent material particles and the sealing material particles. In this example, oxynitride fluorescent material is used as the fluorescent material of the light emitting section 5.

First, the fluorescent material powder and the glass powder were weighed so as to be in a mixed ratio of (glass powder):(CASN:Eu):(Ca-α-SiAlON:Ce)=7:1:2 by mass ratio, and thereafter the powders were mixed together.

Furthermore, to 1 g of this mixed powder, 0.5 ml of pure water was added, which water served as the dispersion medium. This mixture of the mixed powder and pure water was put into a container and was stirred (mixing process).

In the Example, pure water was used as the solvent to prevent the luminous efficiency from decreasing, as described above.

The mixture finally obtained was left to stand at 100° C. for 1 hour (dispersion medium evaporation process) and was treated with heat at 560° C. for half an hour (heat treatment process), to produce the light emitting section.

The mixed ratio of the mixed powder and the pure water, that is, the relative amount of the dispersion medium (water) to the mixture of the fluorescent material particles and sealing material particles are not limited to those described above. The mixed ratio may be any mixed ratio as long as the powder present in the mixture obtained by stirring the mixed powder and the pure water is prevented from being unbalanced in distribution of the powder caused by floating or precipitation caused by the difference in density with the pure water. In other words, the relative amount of the dispersion medium is sufficient as long as the distribution of the fluorescent material particles and the sealing material particles in the dispersion medium is maintained substantially stable from when the mixture is stirred to at least after completion of the heat treatment process.

In the Example, good results were obtained by adding not less than 0.1 ml but not more than 1 ml of pure water.

Moreover, in the Example, the dispersion medium into which the mixed powder was mixed was pure water in view of easy management of the working environment, material costs, production costs and the like, however the dispersion medium is not limited to water. The dispersion medium which can be used in the present invention may be any dispersion medium as long as the dispersion medium does not react with the mixed powder during the mixing and stirring with the mixed powder, during the solvent evaporation process and the heat treatment process, and further does not serve as a reaction catalyst of the mixed powder.

(Production Example 2 of Light Emitting Section)

Next described is another specific example of producing a light emitting section by adding a dispersion medium to a mixture of the fluorescent material particles and the sealing material particles. In this example, sulfide fluorescent material is used as the fluorescent material of the light emitting section 5.

First, the fluorescent material powder and the glass powder were weighed so as to be in a mixed ratio of (glass powder):(CaS:Eu)=95:5 by mass ratio, and were mixed together. Further to 1 g of this mixed powder, 0.6 ml of dehydrated ethanol was added, which dehydrated ethanol served as the dispersion medium. The mixture of the mixed powder and dehydrated ethanol was put into a container, and was stirred (mixing process). As the dehydrated ethanol, reagent grade ethanol (99.5%) available from Kishida Chemical Co., Ltd. whose moisture content is not more than 0.2% may be suitably used.

The dehydrated ethanol is used as the solvent since, as described above, the sulfide fluorescent material has low water resistance, and the user of water as the dispersion medium would cause deterioration of the sulfide fluorescent material, thereby causing the luminous efficiency to decrease.

The mixture finally obtained is left to stand for 1 hour at 80° C. (dispersion medium evaporation process) and was treated with heat at 560° C. for half an hour (heat treatment process), to produce the light emitting section.

The mixed ratio of the mixed powder and the dehydrated ethanol is not limited to the proportion described above. As described above, in a mixture finally obtained by stirring the mixed powder and the dehydrated ethanol together, the dehydrated ethanol may be of an amount that the powder mixed in the mixture does not float or precipitate due to the difference in density with that of the dehydrated ethanol.

In the Example, good results were obtained by adding not less than 0.05 ml but not more than 1 ml of dehydrated ethanol. Moreover, the solvent to be mixed to the mixed powder was dehydrated ethanol in the Example, however the solvent is not limited to this. The dispersion medium used in the present invention may be any dispersion medium which does not react with the mixed powder while mixing and stirring with the mixed powder and during the solvent evaporation process and heat treatment process, and which does not work as a reaction catalyst of the mixed powder. Particularly, in a case where the sulfide fluorescent material is used as the fluorescent material as in the Example, it is preferable that a water content of the solvent is not more than 0.5%.

(Specific Example of Low Melting Glass)

<SiO₂—B₂O₃—CaO—BaO—Li₂O—Na₂O Glasses>

As described above, it is preferable to use low melting glass as the sealing material. As this low melting glass, for instance SiO₂—B₂O₃—CaO—BaO—Li₂O—Na₂O glasses may be used, as described above.

The density of the SiO₂—B₂O₃—CaO—BaO—Li₂O—Na₂O glasses is around 3 g/cm³, and the fluorescent material used in the light emitting section 5 (more specifically, oxynitride fluorescent material and nitride fluorescent material) has a density range of not less than 2.5 g/cm³ to not more than 4.0 g/cm³. Since the density of the glass is close to that of the fluorescent material, it becomes easy to evenly disperse the fluorescent material particles in the glass particles.

As a result, heat generated from each of the fluorescent material particles is conducted into the glass serving as the sealing material, which prevents the light emitting section from becoming locally high in temperature. Hence, it is possible to hold down the deterioration of the light emitting section and extend its life. Furthermore, preventing the local high temperature of the light emitting section also prevents local thermal expansion of the light emitting section. This as a result prevents the generation of cracks and breakage of the light emitting section caused by stress given on the light emitting section due to the difference in thermal expansion at parts of the light emitting section. Moreover, the variation of quality at the time of production is reduced in degree, which thus allows for reducing production costs.

<Borosilicate Glass>

Moreover, borosilicate glass may be used as the low melting glass. The composition of the borosilicate glass is, for example, SiO₂—B₂O₃—Al₂O₃—La₂O₃—R₂O—RO. In the Example, R of R₂₀ is an alkali metal, and R of RO is an alkaline earth metal. The alkali metal may be selected from Li, Na, and K, and the alkaline earth metal may be selected from Mg, Ca, and Sr. For example, a borosilicate glass using Na as the alkali metal and Ca as the alkaline earth metal may be used.

The borosilicate glass is low in thermal expansivity as compared to other glasses, for example phosphate glass. Hence, it is possible to hold down the expansion caused by heat generated in the light emitting section 5.

It is extremely important at this time that when light emitted from the light emitting point (light emitting section 5) is reflected to a desired direction with the reflecting mirror 6, the light emitting section 5 is disposed in a predetermined position (close to the focus) of the reflecting mirror 6 in a predetermined size.

This is because if the position of the light emitting section 5 shifts from the focus of the reflecting mirror 6 even by several ten μm, not enough luminous flux can be irradiated to the desired direction. A more minutely sized light emitting point, the greater the effect caused by this shift in position. Hence, when a minute light emitting section 5 is to be used, the positioning of the light emitting section 5 is extremely important.

Moreover, a case where the size of the light emitting section 5 changes, caused by for example thermal expansion, also serves similarly as the shifting of the light emitting point from its proper position. This may also cause insufficient irradiation of luminous flux to the desired direction.

With this case also, the more minute size the light emitting section 5 is, the greater the effect given caused by the size change.

For these reasons, it is important to prevent the position and size of the light emitting section 5 from changing from the predetermined position or size, which change is caused by the temperature increase of the light emitting section 5.

By using borosilicate glass as the sealing material, it is possible to prevent the light emitting section 5 from increasing in temperature, which increase in temperature serves as a cause for thermal expansion. Therefore, it is possible to reduce the possibility that not enough luminous flux is emitted to the desired direction, which insufficient luminous flux is caused by the thermal expansion of the light emitting section 5.

Moreover, the borosilicate glass has a higher softening point as compared to for example phosphate glass, and hence is also advantageous in that heat resistance further improves.

The following are examples of glass which brings about a similar effect as the borosilicate glass:lead silicate glass (SiO₂—K₂O—PbO), germanate glass (GeO₂—Al₂O₃—CaO), borate glass (B₂O₃—Al₂O₃—MgO—BaO), and vanadate glass (V₂O₅—ZnO-B₂O₃). Moreover, a plurality of types of these glasses may be used in combination.

<Phosphate Glass>

Moreover, phosphate glass may be used as the low melting glass. The phosphate glass has a relatively low glass softening point (150° C. to 300° C.), so hence it is possible to reduce the damage given on the fluorescent material while the glass powder is mixed with the fluorescent material powder and heat treatment is carried out to this mixture. Furthermore, it is possible to hold down the decrease in luminous efficiency caused by the production of the light emitting section 5. Moreover, this allows for using fluorescent material which is not that high in heat resistance. Hence, it is possible to broaden the selection of fluorescent material.

A basic composition of the phosphate glass is P₂O₅—BaO—MgO—ZnO. A refractive index thereof is 1.55 to 1.72 (according to Japanese Patent Application Publication, Tokukai, No. 2004-315324 A (HOYA)).

<Low Melting Glass Containing Lead>

If lead is contained in low melting glass, thermal conductivity of the low melting glass improves as compared to that not containing lead. Hence, it is possible to efficiently disperse heat generated by the light emitting section 5 by the light emitting section 5 being irradiated with excitation light, and efficiently release the heat to other members that the light emitting section 5 is in contact with. This allows for holding down the temperature increase of the light emitting section 5, holding down the decrease in luminous efficiency of the fluorescent material, and taking out illumination light which has a higher luminous flux.

If the temperature increase of the light emitting section 5 is excessive, the light emitting section 5 may deteriorate. However, it is also possible to prevent the deterioration of the light emitting section 5 by the foregoing configuration. For instance, by containing lead in the low melting glass, it is possible to prevent the light emitting section 5 from melting caused by the heat of the excitation light. Hence, the possibility that the lead melts out from the light emitting section 5 is reduced.

Since the low melting glass containing lead has high transmittance, it is possible to reduce the loss when the fluorescence generated by the fluorescent material is emitted outside the light emitting section 5. As a result, it is possible to achieve a light emitting section which is highly efficient in energy use. This effect also can be achieved in a case where excitation light transmitted through the light emitting section 5 is used as the illumination light.

A specific example of a usable low melting glass containing lead is B₂O₃—PbO—SiO₂ glasses. This glass has a 10% higher thermal conductivity as compared to glass not containing lead such as B₂O₃—SiO₂ glass for example, and heat generated by the light emitting section 5 can be efficiently released to other members which are in contact with the light emitting section 5.

Moreover, by use of the B₂O₃—PbO—SiO₂ glasses, the transmittance can be increased by 5% than that of the B₂O₃—SiO₂ glasses.

In the case where lead is contained in the low melting glass which serves as the sealing material of the light emitting section, it is important to establish a lead collecting technique when discarding an illuminating device including the light emitting section and a lead leakage prevention technique during usage of the illuminating device.

<Element improving Thermal Conductivity of Low Melting Glass>

As an element which improves thermal conductivity of low melting glass, magnesium, boron, calcium, aluminum, iron, zinc, and antimony may also be raised as examples, other than the foregoing lead. Moreover, these elements may be used in combination. Namely, by containing at least one of elements selected from the group consisting of magnesium, boron, calcium, aluminum, iron, zinc, and antimony in the low melting glass used as the sealing material of the light emitting section, it is possible to improve the thermal conductivity of the low melting glass.

The thermal conductivity of the glass differs depending on the composition, however a thermal conductivity κ can be calculated from a ratio of the composition. For instance, the thermal conductivity κ of the glass may be calculated by the following formula (I):

$$\begin{matrix}Math . 1 & \\ {10}^{5} κ = {\sum }_{i} {f}_{i} {G}_{i} & ( 1 )\end{matrix}$$

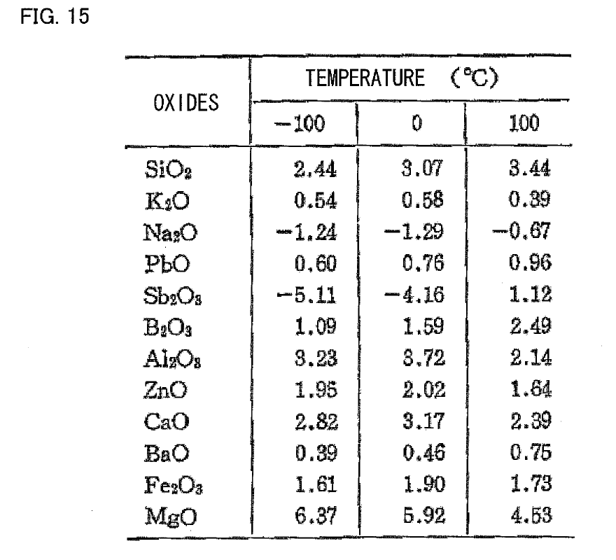

The formula (I) is a formula for calculating a thermal conductivity κ of glass from a component oxide i and its percentage by weight Gi. The coefficient fi in the formula (I) is a coefficient established by Ratcliffe. A specific example of the coefficient fi for calculating the thermal conductivity κ of glass for three types of temperatures from the percentage by weight of the component oxide is shown in FIG. 15.

As shown in formula (I), the higher the value of the coefficient fi, the higher the thermal conductivity κ. The thermal conductivity κ calculated with use of the coefficient fi is said to be different by not more than 5% from an actually-measured value.

As shown in FIG. 15, examples other than lead (PbO) as the oxides for improving the thermal conductivity of the glass encompass MgO, B₂O₃, CaO, Al₂O₃, Fe₂O₃, ZnO, and Sb₂O₃. With a high thermal conductivity of the glass, heat can be released so that the light emitting section does not deteriorate even if the size of the light emitting section is made thicker or larger, and can extend the heat releasing distance.

(Modification)

The present invention is not limited to the description of the embodiments above, but may be altered by a skilled person within the scope of the claims. An embodiment based on a proper combination of technical means disclosed in different embodiments is encompassed in the technical scope of the present invention.

Moreover, a solid laser other than the laser diode may be used as the excitation light source. Note however that the laser diode is preferable, because the laser diode allows for downsizing the excitation light source.

(Additional Matters)

An embodiment of the present invention may also be expressed as described below.

It is preferable that the heat-resistant fluorescent material have a quantum efficiency not decreasing to an extent outside an error range at least in a case where heat treatment is carried out within a temperature range of 0° C. to 560° C., the quantum efficiency being compared between a quantum efficiency of the heat-resistant fluorescent material being measured prior to the heat treatment at a certain temperature and a quantum efficiency of the heat-resistant fluorescent material being measured at the certain temperature after being subjected to the heat treatment.

Generally, quantum efficiency of fluorescent material decreases upon an increase in its surrounding temperature (environmental temperature), and thereafter increases back upon decrease in the environmental temperature. Normally, this change in quantum efficiency dependent on the temperature (temperature dependence of quantum efficiency) occurs reversibly. However, upon heating the fluorescent material to a certain temperature or a higher temperature (called high heat treatment), the temperature dependence of the quantum efficiency may change, which change causes a quantum efficiency of the fluorescent material at a predetermined temperature (e.g. room temperature) after the fluorescent material is subjected to the high heat treatment be lower than that of the predetermined temperature prior to the high heat treatment. The decrease in this quantum efficiency is not reversible.

According to the configuration, the temperature dependence of the quantum efficiency of heat-resistant fluorescent material hardly changes even if the fluorescent material is heated to near 560° C. Namely, the quantum efficiency measured at a certain temperature (e.g. room temperature) upon heat treatment hardly decreases as compared to the quantum efficiency measured at the certain temperature prior to the heat treatment.

Hence, even in a case where the heat-resistant fluorescent material is temporarily heated with a high temperature for a purpose such as sealing the heat-resistant fluorescent material in the heat-resistant transparent sealing material, the luminous efficiency of the heat-resistant fluorescence material hardly decreases.

Accordingly, it is possible to prevent the heat-resistant fluorescent material from deteriorating caused by an increase in its surrounding temperature, such as the temperature increase caused in the production of the light emitting section.

As long as the difference in the quantum efficiencies between that measured prior to the heat treatment and that measured after the heat treatment is within a predetermined range, the change in quantum efficiency with respect to temperature change does not necessarily need to be completely unchanging throughout the temperature range in which the quantum efficiency is measured prior to and after the heat treatment. Alternatively, it is sufficient as long as the temperature dependence of the quantum efficiency of heat-resistant fluorescent material within a certain temperature range hardly changes between that prior to and that after the heat treatment. Note that the certain temperature range may be set as appropriate by a person skilled in the art.

Moreover, it is preferable that the heat-resistant fluorescent material include oxynitride fluorescent material, nitride fluorescent material, or nanoparticle fluorescent material consisting of a III-V compound semiconductor

These fluorescent material have excellent heat resistance, so therefore it is possible to achieve a light emitting section which has excellent heat resistance.

Moreover, it is preferable that the heat-resistant transparent sealing material be low melting glass, and the heat-resistant fluorescent material and the heat-resistant transparent sealing material be included in the light emitting section in a mass ratio of not less than 0.5:100 but not more than 20:100.

Moreover, it is preferable that the heat-resistant transparent sealing material be organic-inorganic hybrid glass, and the heat-resistant fluorescent material and the organic-inorganic hybrid glass are included in the light emitting section in a mass ratio of not less than 5.13:200 but not more than 50:200.

The inventor of the present invention found that deterioration caused by heat of the fluorescent material can be prevented by adjusting (i) the material of the sealing material and (ii) a mixed ratio of the sealing material with the fluorescent material. More specifically, by use of low melting glass or organic-inorganic hybrid glass as the heat-resistant transparent sealing material, and by having the foregoing mixed ratio, it is possible to prevent the generation of heat by the light emitting section caused by the irradiation with the laser beam, and prevent the deterioration of the fluorescent material by heat.

Moreover, it is preferable that the oxynitride fluorescent material include Caα-SiAlON (silicon aluminum oxynitride):Ce fluorescent material, Caα-SiAlON:Eu fluorescent material, or β-SiAlON:Eu fluorescent material. Moreover, it is preferable that the nitride fluorescent material include CASN:Eu fluorescent material or SCASN:Eu fluorescent material.

These oxynitride fluorescent material and nitride fluorescent material have excellent heat resistance, and hence can achieve a light emitting section having excellent heat resistance.

Moreover, it is preferable that the laser beam emitted to the light emitting section has an emission density of not less than 0.1 W/mm² but not more than 50 W/mm².

According to the configuration, it is possible to generate illumination light which has high brightness, which allows for attaining a light emitting device which can be suitably applied particularly to a headlamp.

Moreover, an illuminating device including the light emitting device and a vehicle headlamp including the light emitting device are also within the technical scope of the present invention.

Moreover, it is preferable that the density of the sealing material be not less than 2.0 g/cm³ but not more than 6.0 g/cm³ where the average particle size of the fluorescent material is not smaller than 1 μm but not larger than 50 μm.

Furthermore, it is preferable that the density of the fluorescent material be not less than 6.10 g/cm³ but not more than 6.87 g/cm³ where the average particle size of the fluorescent material is not larger than 50 nm.

Moreover, it is preferable that the fluorescent material having the average particle size of not smaller than 1 μm but not larger than 50 μm include oxynitride fluorescent material or nitride fluorescent material.

The oxynitride fluorescent material and nitride fluorescent material are fluorescent material which have excellent heat resistance and temperature properties, and the inventor of the present invention has confirmed by experimentation that the oxynitride fluorescent material and nitride fluorescent material tolerate high output and high optical density laser beams. Hence, by use of the oxynitride fluorescent material or the nitride fluorescent material, it is possible to attain a wavelength conversion member which can be applied to a light emitting device having high output and high optical density.

The temperature properties indicate how much the properties of the fluorescent material change when comparing for examples properties of the fluorescent material at room temperature with properties of the fluorescent material in a certain environmental temperature that is different from the room temperature, which environmental temperature denotes a surrounding temperature of the fluorescent material. Having excellent temperature properties means that an amount of change in property values of the fluorescent material in accordance with the environmental temperature change is small. The oxynitride fluorescent material or nitride fluorescent material has excellent temperature properties as compared to YAG:Ce fluorescent material, which is an extremely typical fluorescent material for LED.

Moreover, it is preferable that the sealing member be glass material.

Use of glass material as the sealing material allows for increasing the heat resistance of the wavelength conversion member.

Moreover, it is preferable that the glass material be low melting glass.

According to the configuration, it is possible to carry out the production of the wavelength conversion member at a low temperature, which makes it easier to produce the wavelength conversion member.

Moreover, it is preferable that the low melting glass contain at least one element selected from the group consisting of: magnesium, boron, calcium, aluminum, iron, zinc, and antimony.

By containing these elements in the low melting glass, it is possible to increase the thermal conductivity of the low melting glass.

Moreover, it is preferable that the low melting glass contain glass of SiO₂—B₂O₃—CaO—BaO—Li₂O—Na₂O glasses.

SiO₂—B₂O₃—CaO—BaO—Li₂O—Na₂O glasses have a density of around 3 g/cm³, and fluorescent material used for the wavelength conversion member has a density range from not less than 2.5 g/cm³ to not more than 4.0 g/cm³. Since the density of the glass and the fluorescent material is of a close value, it is easier to evenly disperse the fluorescent material particles into the glass particles.

Moreover, it is preferable that the low melting glass contain borosilicate glass, lead silicate glass, germanate glass, borate glass, or vanadate glass.

The glasses listed above have lower thermal expansivity as compared to other glasses such as phosphate glass, and thus can hold down the expansion of the wavelength conversion member caused by the heat lower in degree.

Hence, it is possible to prevent the position and size of the wavelength conversion member from changing from a predetermined size caused by the increase in temperature of the wavelength conversion member. As a result, it is possible to reduce the possibility that a sufficient amount of luminous flux cannot be taken out in a desired direction that is caused by a change in the position or the size from a predetermined position or size.

Moreover, it is preferable that the low melting glass contain phosphate glass.

Since phosphate glass is glass which has a particularly low glass softening point (150° C. to 300° C.) among the low melting glasses, it is possible to particularly reduce the temperature of the heat treatment when treating the mixture of the low melting glass with the fluorescent material. Hence, it is possible to reduce the damage on the fluorescent material and hold down the reduction in luminous efficiency caused by the heat generated when producing the wavelength conversion member.

Moreover, a light emitting device including the wavelength conversion member and an excitation light source configured to emit excitation light to the wavelength conversion member, and an illuminating device and a vehicle headlamp each of which including the light emitting device, are also included within the technical scope of the present invention.

By applying the wavelength conversion member to the light emitting device, illuminating device or the vehicle headlamp, it is possible to extend the life of these devices and improve their reliability.

Moreover, it is preferable that the excitation light source include a light emitting diode.

By use of a light emitting diode (LED) as the excitation light source, it is possible to reduce the size of the light emitting device itself, which includes the excitation light source and the wavelength conversion member. This enhances the freedom in the range of applicable products of the light emitting device. Moreover, since the LED chip is low in cost, it is possible to aim for reduction of costs of the light emitting device.

Moreover, it is preferable that the excitation light source emit a laser beam.

By use of a light source which emits a laser beam, excitation light of an extremely high power and an extremely high power density is obtainable. Hence, it becomes possible to take out illumination light having high brightness and high luminous flux from the wavelength conversion member.

Moreover, it is preferable that the excitation light source include a laser diode.

By having the excitation light source be a laser diode, the light emitting device itself made up of the excitation light source and the wavelength conversion member can be made small-sized since the laser diode is small in size. This further enhances the freedom in a range of applicable products of the light emitting device. Moreover, it is possible to further enhance the freedom in design of a product using the light emitting device.

Moreover, it is preferable that in the step (a) in the production method according to the present invention, the fluorescent material be mixed with the sealing material with an addition of a liquid serving as a dispersion medium.

According to the configuration, even if there was a slight difference in density and particle size of the fluorescent material and the sealing material, it is possible to evenly disperse the fluorescent material and the sealing material in the liquid that serves as the dispersion medium. As a result, it is possible to evenly disperse the fluorescent material in the sealing material.

This thus makes the generation of heat by the fluorescent material at the time of excitation be even, whereby preventing the wavelength conversion member from locally becoming a high temperature. As a result, it is possible to prevent deterioration (property decrease) of the wavelength conversion member and deterioration of the sealing material caused by discoloring, change in quality and the like. Moreover, since it becomes possible to prevent the wavelength conversion member from cracking caused by a difference in thermal expansion due to the local high temperature, it is possible to extend its life. Furthermore, it is also possible to prevent the change in mixed ratio of the fluorescent material and the sealing material before and after production of the wavelength conversion member, which change is caused by the scattering of the fluorescent material and/or sealing material by static electricity or the like.

Moreover, in the step (a) included in the production method according to the present invention, it is preferable that the fluorescent material include oxynitride fluorescent material or nitride fluorescent material, and the liquid be water.

According to the configuration, if the used fluorescent material includes oxynitride fluorescent material or nitride fluorescent material, use of water as the liquid allows for evenly stirring the fluorescent material powder with the sealing material without reducing the luminous efficiency of the fluorescent material.

Moreover, in the step (a) included in the production method according to the present invention, it is preferable that the fluorescent material include sulfide fluorescent material, and the liquid be a liquid containing water content of not more than 0.5% by volume.

If the fluorescent material to be used were sulfide fluorescent material, a large content of water in the liquid would reduce the luminous efficiency of the fluorescent material. According to the configuration, hardly any water is contained in the liquid. Hence, it is possible to evenly stir the fluorescent material powder with the sealing material without causing the decrease in luminous efficiency of the fluorescent material.

Moreover, it is preferable that the liquid be added by an amount in which spaces between particles of the fluorescent material and particles of the sealing material are filled.

According to the configuration, the added amount of the liquid is an amount which fills the spaces between the particles of the fluorescent material and the particles of the sealing material. Hence, it is possible to stably and evenly disperse the particles of the fluorescent material and the particles of the sealing material in the liquid as a dispersion medium. As a result, it is possible to prevent the distribution of both particles from becoming unbalanced until the mixture of the fluorescent material particles and the sealing material particles are finally treated with heat to form the wavelength conversion member.

The “stably” described above denotes a state in which the fluorescent material particles and the sealing material particles are even in distribution, during the time required for producing the wavelength conversion member.

Moreover, the present invention may also be expressed as follows.

Namely, the wavelength conversion member of the present invention is a wavelength conversion member configured to emit light upon receiving excitation light, the wavelength conversion member being prepared from at least two types of base materials of fluorescent material and glass powder. As the fluorescent material, one or two or more types from among oxynitride fluorescent material or nitride fluorescent material is selected, and the fluorescent material has an average particle size of for example 1 μm to 50 μm and the glass powder has an average particle size of larger than 0 but not larger than 350 μm.

According to an embodiment of the present invention, one type or two or more types of the fluorescent material may be selected from among the oxynitride fluorescent material or the nitride fluorescent material.

According to an embodiment of the present invention, the fluorescent material may contain a semiconductor nanoparticle fluorescent material having particles of a nanometer size.

According to an embodiment of the present invention, a mixed ratio of the fluorescent material powder and the glass powder may be in a range of 30:70 to 50:50 by mass ratio.

### INDUSTRIAL APPLICABILITY

The present invention is applicable to a light emitting device having a high luminance and a long life. Particularly, the present invention is applicable to a headlamp for a vehicle and the like.

### REFERENCE SIGNS LIST

1 headlamp (light emitting device, vehicle headlamp)
2 laser diode
5 light emitting section
20 headlamp (light emitting device, vehicle headlamp)
30 headlamp (light emitting device, vehicle headlamp)
51 light emitting section
52 light emitting section
200 laser downlight (illuminating device)

What is claimed is:

1. A light emitting device comprising:
a laser diode configured to emit a laser beam; and
a light emitting section configured to emit light upon receiving the laser beam emitted from the laser diode,
the light emitting section having heat-resistant (heat-tolerant) fluorescent material being dispersed inside heat-resistant transparent sealing material.

2. The light emitting device according to claim 1, wherein:
the heat-resistant fluorescent material has a quantum efficiency not decreasing to an extent outside an error range at least in a case where heat treatment is carried out within a temperature range of 0° C. to 560° C., the quantum efficiency being compared between a quantum efficiency of the heat-resistant fluorescent material being measured prior to the heat treatment at a certain temperature and a quantum efficiency of the heat-resistant fluorescent material being measured at the certain temperature after being subjected to the heat treatment.

3. The light emitting device according to claim 1, wherein:
the heat-resistant fluorescent material includes oxynitride fluorescent material, nitride fluorescent material, or nanoparticle fluorescent material consisting of a III-V compound semiconductor.

4. The light emitting device according to claim 1, wherein:
the heat-resistant transparent sealing material is low melting glass, and
the heat-resistant fluorescent material and the heat-resistant transparent sealing material are included in the light emitting section in a mass ratio of not less than 0.5:100 but not more than 20:100.

5. The light emitting device according to claim 1, wherein:
the heat-resistant transparent sealing material is organic-inorganic hybrid glass, and
the heat-resistant fluorescent material and the organic-inorganic hybrid glass are included in the light emitting section in a mass ratio of not less than 5.13:200 but not more than 50:200.

6. The light emitting device according to claim 3, wherein:
the oxynitride fluorescent material includes Caα-SiAlON (silicon aluminum oxynitride):Ce fluorescent material, Caα-SiAlON:Eu fluorescent material, or β-SiAlON:Eu fluorescent material, and
the nitride fluorescent material includes CASN:Eu fluorescent material or SCASN:Eu fluorescent material.

7. The light emitting device according to claim 1, wherein:
the laser beam emitted to the light emitting section has an emission density of not less than 0.1 W/mm² but not more than 50 W/mm².

8. A wavelength conversion member comprising:
fluorescent material converting a wavelength of excitation light; and
sealing material sealing the fluorescent material,
the fluorescent material having a density of not less than 2.5 g/cm³ but not more than 4.0 g/cm³ and the sealing material having a density of not less than 2.0 g/cm³ but not more than 7.0 g/cm³ where the fluorescent material has an average particle size of not smaller than 1 μm but not larger than 50 μm, and
the fluorescent material having a density of not less than 6.0 g/cm³ but not more than 7.0 g/cm³ and the sealing material having a density of not less than 2.0 g/cm³ but not more than 12 g/cm³ where the fluorescent material has an average particle size of not larger than 50 nm.

9. The wavelength conversion member according to claim 8, wherein:
the density of the sealing material is not less than 2.0 g/cm³ but not more than 6.0 g/cm³ where the average particle size of the fluorescent material is not smaller than 1 μm but not larger than 50 μm.

10. The wavelength conversion member according to claim 8, wherein:
the density of the fluorescent material is not less than 6.10 g/cm³ but not more than 6.87 g/cm³ where the average particle size of the fluorescent material is not larger than 50 nm.

11. The wavelength conversion member according to claim 8, wherein:
the fluorescent material having the average particle size of not smaller than 1 μm but not larger than 50 μm includes oxynitride fluorescent material or nitride fluorescent material.

12. The wavelength conversion member according to claim 8, wherein:
the sealing member is glass material.

13. The wavelength conversion member according to claim 12, wherein:
the glass member is low melting glass.

14. The wavelength conversion member according to claim 13, wherein:
the low melting glass contains at least one element selected from the group consisting of: magnesium, boron, calcium, aluminum, iron, zinc, and antimony.

15. The wavelength conversion member according to claim 13, wherein
the low melting glass contains glass of SiO₂—B₂O₃—CaO—BaO—Li₂O—Na₂O glasses.

16. The wavelength conversion member according to claim 13, wherein
the low melting glass contains borosilicate glass, lead silicate glass, germanate glass, borate glass, or vanadate glass.

17. The wavelength conversion member according to claim 13, wherein
the low melting glass contains phosphate glass.

18. A light emitting device comprising:
a wavelength conversion member as set forth in claim 8; and
an excitation light source configured to emit excitation light to the wavelength conversion member.

19. The light emitting device according to claim 18, wherein
the excitation light source includes a light emitting diode.

20. The light emitting device according to claim 18, wherein
the excitation light source emits a laser beam.

21. The light emitting device according to claim 20, wherein
the excitation light source includes a laser diode.

22. An illuminating device comprising a light emitting device as set forth in claim 1.

23. An illuminating device comprising a light emitting device as set forth in claim 8.

24. A vehicle headlamp comprising a light emitting device as set forth in claim 1.

25. A vehicle headlamp comprising a light emitting device as set forth in claim 8.

26. A method of producing a wavelength conversion member, the method comprising the steps of:
(a) mixing fluorescent material with sealing material, the fluorescent material having a density of not less than 2.5 g/cm³ but not more than 4.0 g/cm³ and the sealing material having a density of not less than 2.0 g/cm³ but not more than 7.0 g/cm³ where the fluorescent material has an average particle size of not smaller than 1 μm but not larger than 50 μm, and the fluorescent material having a density of not less than 6.0 g/cm³ but not more than 7.0 g/cm³ and the sealing material having a density of not less than 2.0 g/cm³ but not more than 12 g/cm³ where the fluorescent material has an average particle size of not larger than 50 nm; and
(b) treating a mixture of the fluorescent material and the sealing material prepared in the step (a), by heat.

27. The method according to claim 26, wherein:
in the step (a), the fluorescent material is mixed with the sealing material with an addition of a liquid serving as a dispersion medium.

28. The method according to claim 27, wherein:
the fluorescent material includes oxynitride fluorescent material or nitride fluorescent material, and
the liquid is water.

29. The method according to claim 27, wherein:
the fluorescent material includes sulfide fluorescent material, and
the liquid is a liquid containing water content of not more than 0.5% by volume.

30. The method according to claim 27, wherein
the liquid is added by an amount in which spaces between particles of the fluorescent material and particles of the sealing material are filled.
